(19) United States
(12) Patent Application Publication
(10) Pub. No.: US 2019/0116175 A1
(43) Pub. Date: Apr. 18, 2019

(54) INFORMATION PROCESSING APPARATUS, CONTROL METHOD OF INFORMATION PROCESSING APPARATUS, AND PROGRAM

(71) Applicant: KONICA MINOLTA, INC., Tokyo (JP)

(72) Inventors: Hirokazu Sasamoto, Osaka (JP); Kenji Fukudome, Kawanabe-gun (JP)

(73) Assignee: KONICA MINOLTA, INC., Tokyo (JP)

(21) Appl. No.: 16/128,567

(22) Filed: Sep. 12, 2018

(30) Foreign Application Priority Data
Oct. 13, 2017 (JP) 2017-199590

(51) Int. Cl. H04L 29/06; G06F 21/33; G06F 21/60; G06F 9/455

(52) U.S. Cl. CPC H04L 63/0823; G06F 9/45558; G06F 21/608; G06F 21/33

(57) ABSTRACT

An information processing apparatus constructs virtual environments, and includes: a first storage provided in a first virtual environment, the first storage storing a first certificate for verification; a second storage provided in a second virtual environment, the second storage capable of storing a second certificate for verification; a certificate manager that acquires the first certificate for verification from the first storage or from another part different from the first storage, and automatically stores the first certificate for verification in the second storage, as the second certificate for verification; a first verification processor that operates in the first virtual environment, and uses the first certificate for verification stored in the first storage to verify the first server certificate; and a second verification processor that operates in the second virtual environment, and uses the second certificate for verification stored in the second storage to verify the second server certificate.

The entire disclosure of Japanese patent Application No. 2017-199590, filed on Oct. 13, 2017, is incorporated herein by reference in its entirety.

### BACKGROUND

### Technological Field

The present invention relates to an information processing apparatus such as a multi-functional peripheral (MFP) and a related technique.

### Description of the Related Art

When communication is performed between a server computer (also simply referred to as a server) and a client computer (also simply referred to as a client), there is a technique that utilizes a server certificate as a technique for guaranteeing identity of a server (see the column of Description of the Related art and the like of JP 2007-274457A). The server certificate is an electronic certificate that guarantees identity of a company or the like that operates a server (web site, or the like). As the server certificate, a secure sockets layer (SSL) server certificate is often utilized The SSL server certificate is utilized in SSL communication involving encryption of communication by a public key and a secret key.

The SSL server certificate has a server authentication function (server certificate verification function) based on a public key certificate (certificate for verification). Specifically, when a server certificate is transmitted from a server, whether the server certificate is legitimate (reliability of the server certificate) is verified.

As a verification technique of the server certificate, for example, there are the following two. One is a technique of utilizing “a certificate issued by a trusted certificate authority” (C10) stored in advance in a client, as a verification certificate (see FIG. 31). The other one is a technique of installing a “self-signed certificate” (C11) in the client in advance (before downloading of the server certificate) and utilizing the self-signed certificate (C11) as the certificate for verification (see FIG. 32).

It is conceivable to construct a plurality of virtual environments in an MFP. For example, it is conceivable to construct an “IWS platform virtual environment” as a first virtual environment 50 and to construct an “operation panel virtual environment” as a second virtual environment 70. Here, the “IWS platform virtual environment” is a virtual environment in which a platform for an IWS (also referred to as a server provided inside the MFP (internal web server)) is operated, and the “operation panel virtual environment” is a virtual environment (another virtual environment) in which the operation panel is operated. Then, as shown in FIG. 33, in some cases, a first application 51 in the first virtual environment 50 performs encrypted communication with an external server 90, and a second application (browser) 71 in the second virtual environment 70 also performs encrypted communication with the external server 90. Note that FIG. 33 is a conceptual diagram showing a situation in which SSL communication (encrypted communication) is performed in the plurality of virtual environments independently.

In such an MFP having a plurality of virtual environments, SSL communication (encrypted communication) is performed between each virtual environment and the same server (external server). In this case, it is preferable that each virtual environment verifies the server certificate transmitted from the external server.

However, in each virtual environment, it is required to verify the server certificate by using the certificate for verification stored in the virtual environment. For example, a verification processing part in the second virtual environment is required to perform verification processing on the server certificate by using the certificate for verification stored in the same virtual environment (second virtual environment). The verification processing part in the second virtual environment cannot perform verification processing on the server certificate with reference to the certificate for verification stored in the first virtual environment (see FIG. 34). FIG. 34 is a diagram showing that, when the verification processing part of the second virtual environment 70 performs the verification processing of the server certificate, the verification processing part of the second virtual environment 70 cannot refer to the certificate for verification in the first virtual environment 50. In other words, the certificate for verification for verifying the server certificate in each virtual environment is required to be stored in advance in each virtual environment.

Therefore, as shown in FIG. 35, for example, when a “self-signed certificate” is utilized as the certificate for verification, generally, it is required that a task of storing certificates for verification (also referred to as a technique according to the comparative example) is performed for both of the first virtual environment and the second virtual environment. As a result, management of the certificate for verification related to the server certificate becomes complicated. FIG. 35 is a diagram showing a technique according to the comparative example.

As will be described later, even when a “certificate by a trusted certificate authority” is utilized as the certificate for verification, the management of the certificate for verification related to the server certificate becomes complicated in some cases.

### SUMMARY

It is an object of the present invention to provide a technique capable of performing management of a certificate for verification in a plurality of virtual environments relatively easily, in an information processing apparatus that constructs the plurality of virtual environments.

To achieve the abovementioned object, according to an aspect of the present invention, there is provided an information processing apparatus that constructs a plurality of virtual environments, and the information processing apparatus reflecting one aspect of the present invention comprises: a first storage provided in a first virtual environment of the plurality of virtual environments, the first storage storing a first certificate for verification for verifying a first server certificate transmitted from an external server in execution of a first application in the first virtual environment; a second storage provided in a second virtual environment of the plurality of virtual environments, the second storage capable of storing a second certificate for verification for verifying a second server certificate transmitted from the external server in execution of a second application in the second virtual environment; a certificate manager that acquires the first certificate for verification from the first storage or from another part different from the first storage, and automatically stores the first certificate for verification in the second storage, as the second certificate for verification; a first verification processor that operates in the first virtual environment, and uses the first certificate for verification stored in the first storage to verify the first server certificate; and a second verification processor that operates in the second virtual environment, and uses the second certificate for verification stored in the second storage to verify the second server certificate.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram showing a configuration of an information processing system;

FIG. 2 is a diagram showing functional blocks of an MFP;

FIG. 3 is a diagram showing a plurality of virtual machine environments;

FIG. 4 is a diagram showing a plurality of virtual container environments;

FIG. 5 is a diagram showing a plurality of software execution environments (virtual environments);

FIG. 6 is a conceptual diagram showing operation of a first embodiment;

FIG. 7 is a diagram showing a state in which a certificate for verification has not yet been stored in a first virtual environment;

FIG. 8 is a diagram showing a situation in which a first application is installed in the first virtual environment;

FIG. 9 is a diagram showing a situation in which the certificate for verification is stored in a certificate storage of the first virtual environment;

FIG. 10 is a diagram showing a situation in which the certificate for verification is stored in a certificate storage of a second virtual environment;

FIG. 11 is a flowchart showing the operation of the first embodiment;

FIG. 12 is a conceptual diagram showing operation of a second embodiment;

FIG. 13 is a diagram showing a situation in which the first application is installed in the first virtual environment;

FIG. 14 is a diagram showing a situation in which the certificate for verification is stored in the certificate storage of the first virtual environment and in a certificate storage of a third virtual environment;

FIG. 15 is a diagram showing a situation in which the certificate for verification is stored in the certificate storage of the second virtual environment;

FIG. 16 is a flowchart showing the operation of the second embodiment;

FIG. 17 is a conceptual diagram showing operation of the third embodiment;

FIG. 18 is a diagram showing a situation in which a second certificate for verification is deleted along with update processing of the second virtual environment;

FIG. 19 is a diagram showing a situation in which inquiry is made for the certificate for verification to be stored in the second virtual environment, from the second virtual environment to the certificate manager;

FIG. 20 is a diagram showing a situation in which a first certificate for verification is forwarded from the third virtual environment to the second virtual environment;

FIG. 21 is a flowchart showing the operation of the third embodiment;

FIG. 22 is a timing chart showing operation according to a fourth embodiment;

FIG. 23 is a conceptual diagram showing the operation according to the fourth embodiment;

FIG. 24 is a diagram showing a situation in which expiration of the certificate for verification has occurred;

FIG. 25 is a conceptual diagram showing operation according to a modified example of the fourth embodiment;

FIG. 26 is a conceptual diagram showing operation of a fifth embodiment;

FIG. 27 is a diagram showing a situation in which the first certificate for verification has already been stored in the first virtual environment at the time of construction of the first virtual environment in the fifth embodiment;

FIG. 28 is a diagram showing a situation in which the first application is installed in the first virtual environment in the fifth embodiment;

FIG. 29 is a diagram showing a situation in which the first certificate for verification is forwarded from the first virtual environment to the third virtual environment;

FIG. 30 is a diagram showing a situation in which the first certificate for verification is forwarded from the third virtual environment to the second virtual environment;

FIG. 31 is a conceptual diagram showing a technique of utilizing a “certificate issued by a trusted certificate authority” as the certificate for verification;

FIG. 32 is a conceptual diagram showing a technique of utilizing a “self-signed certificate” as the certificate for verification;

FIG. 33 is a conceptual diagram showing a situation in which encrypted communication or the like is performed in a plurality of virtual environments independently;

FIG. 34 is a diagram showing that an application of each virtual environment cannot refer to a certificate for verification in other virtual environments at the time of verification processing of a server certificate;

FIG. 35 is a diagram showing operation according to a comparative example; and

FIG. 36 is a diagram showing operation according to another comparative example.

### DETAILED DESCRIPTION OF EMBODIMENTS

Hereinafter, one or more embodiments of the present invention will be described with reference to the drawings. However, the scope of the invention is not limited to the disclosed embodiments.

### 1. First Embodiment

<1-1. System Configuration>

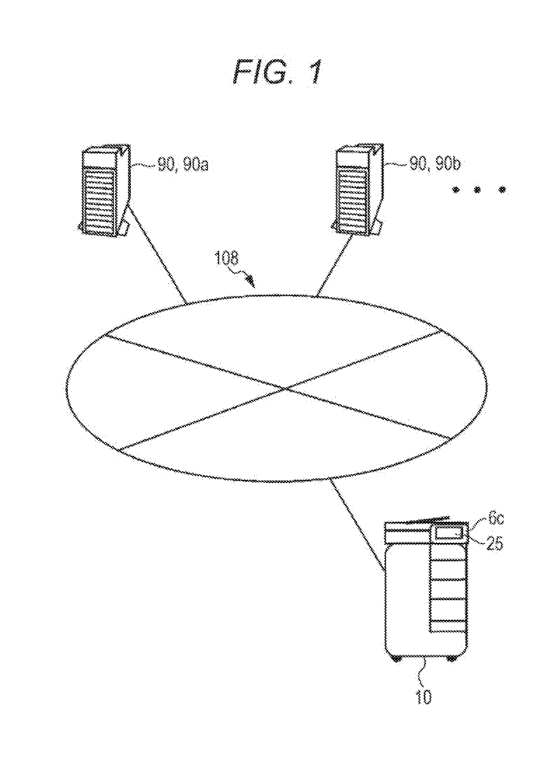

FIG. 1 is a schematic diagram showing a configuration of an information processing system 1 according to a first embodiment of the present invention. As shown in FIG. 1, the information processing system 1 includes an MFP 10 (information processing apparatus) and a server computer 90 (90a, 90b, . . . ). The MFP 10 is also expressed as a client.

The MFP 10 and each server computer (also referred to as an external server or simply a server) 90 are connected to each other via a network 108. The network 108 is composed of a local area network (LAN), the Internet, and the like. A connection manner with respect to the network 108 may be a wired connection or a wireless connection.

Each server 90 is a device of outside (external device) (external server) of the MFP 10. Here, each server 90 is configured as a cloud server.

<1-2. Configuration of MFP 10>

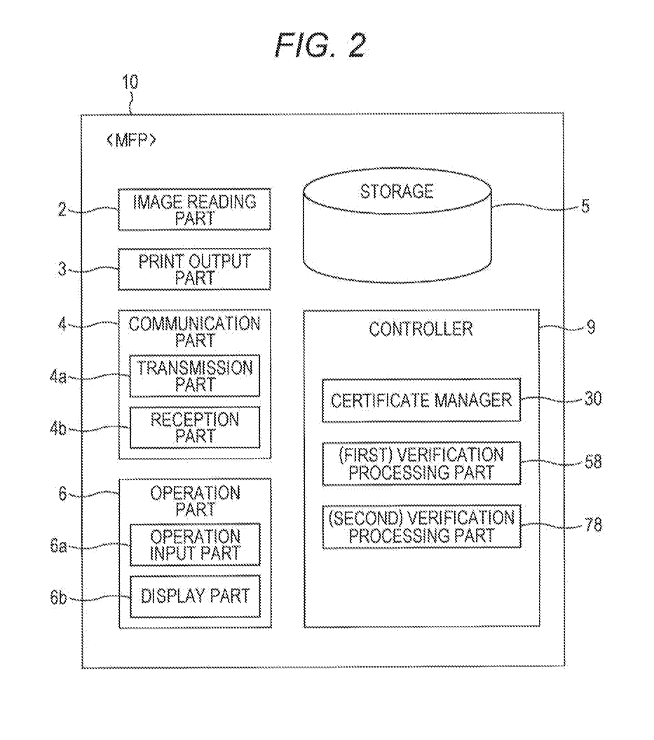

FIG. 2 is a diagram showing functional blocks of a multi-functional peripheral (MFP) 10.

The MFP 10 is an apparatus (also referred to as a multifunction peripheral) including a scan function, a copy function, a facsimile function, a box storage function, and the like. Specifically, as shown in the functional block diagram of FIG. 2, the MFP 10 includes an image reading part 2, a print output part 3, a communication part 4, a storage 5, an operation part 6, a controller 9, and the like, and realizes various functions by multifunctionally operating each of these parts. The MFP 10 is also expressed as an image processing apparatus, an image forming apparatus, or the like.

The image reading part 2 is a processing part that optically reads (that is, scans) a document placed at a predetermined position of the MFP 10 and generates image data of the document (also referred to as a document image or a scanned image) This image reading part 2 is also referred to as a scan part.

The print output part 3 is an output part that prints and outputs an image on various media such as paper on the basis of data related to a print target. The MFP 10 is also an electrophotographic printer (full color printer), and the print output part 3 has various hardware mechanisms such as an exposure part, a developing part, a transfer part, and a fixing part.

The communication part 4 is a processing part capable of performing facsimile communication via a public line or the like. The communication part 4 also can perform network communication via the network 108. In this network communication, for example, various protocols such as a transmission control protocol/internet protocol (TCP/IP) are utilized. The MFP 10 can exchange various data with a desired destination (for example, the server 90) by utilizing the network communication. The communication part 4 has a transmission part 4a that transmits various data and a reception part 4b that receives various data.

The storage 5 is composed of a storage device such as a hard disk drive (HDD).

The operation part 6 includes an operation input part 6a that accepts an operation input to the MFP 10 and a display part 6b that performs display output of various information. In this MFP 10, a substantially plate-like operation panel part 6c (see FIG. 1) is provided, and the operation panel part 6c has a touch panel 25 (see FIG. 1) on its front side. The touch panel 25 is configured by embedding a piezoelectric sensor or the like in a liquid crystal display panel, can display various information, and can accept an operation input from an operator. For example, various screens (including button images and the like) such as a menu screen, and the like are displayed on the touch panel 25. The operator can push a button (button represented by a button image) virtually arranged in the touch panel 25 to change various setting contents of the MFP 10. The touch panel 25 also functions as a part of the operation input part 6a and also functions as a part of the display part 6b.

The controller (control part) 9 is a control device that is built in the MFP 10 and comprehensively controls the MFP 10. The controller 9 is configured as a computer system including a CPU and various semiconductor memories (RAM and ROM) and the like. The controller 9 executes a predetermined software program (hereinafter, referred to as simply a program) stored in a ROM (for example, EEPROM (registered trademark) to realize various processing parts, in the CPU. It should be noted that the program (specifically, a program module group) may be recorded in a portable recording medium such as a USB memory, read out from the recording medium, and installed in the MFP 10. Alternatively, the program may be downloaded via a network or the like and installed in the MFP 10.

Specifically, as shown in FIG. 2, the controller 9 realizes various processing parts including a certificate manager 30 and verification processing parts 58, 78 by executing the program.

The certificate manager 30 is a processing part that manages a server certificate in each virtual environment. The certificate manager 30 manages a certificate for verification stored in a certificate storage provided in a certain virtual environment. The certificate manager 30 performs processing of forwarding each certificate for verification to another virtual environment such that the certificate for verification stored in a certain virtual environment can be utilized in the another virtual environment. For example, the certificate manager 30 acquires a certificate for verification (first certificate for verification) C1 of the first virtual environment 50, and performs processing of automatically storing the first certificate for verification C1 in the second virtual environment 70 as a certificate for verification (second certificate for verification) C2 of the second virtual environment 70.

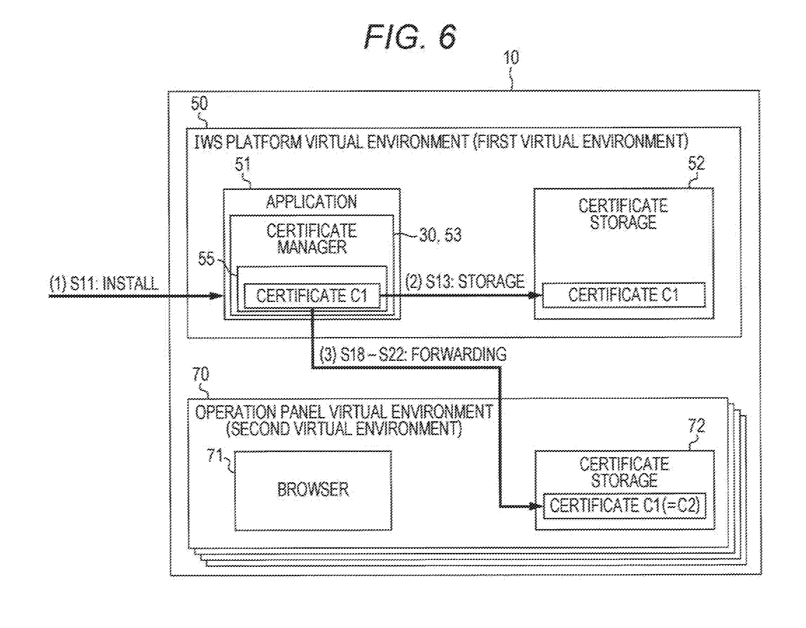

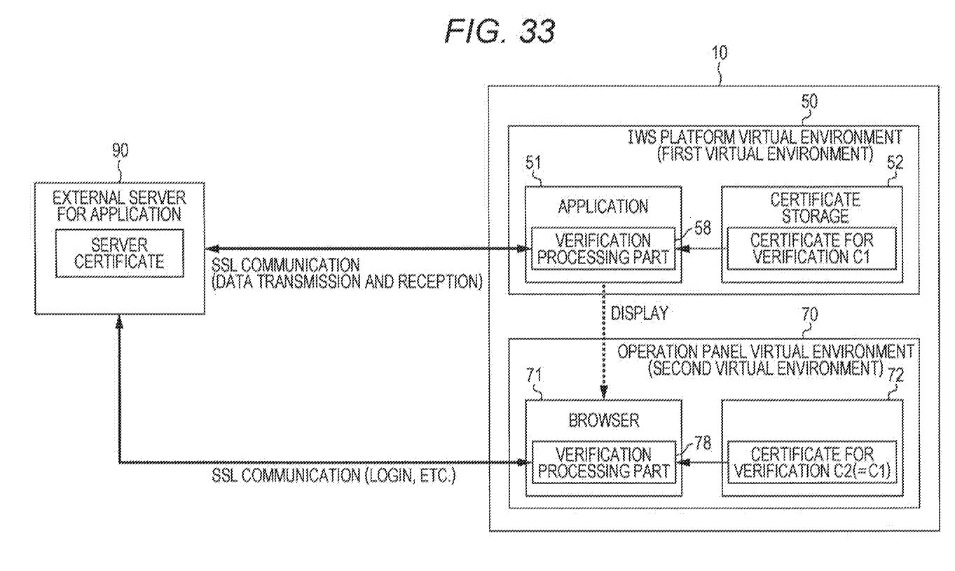

The first verification processing part 58 is a verification processing part operating in the first virtual environment 50. The first verification processing part 58 uses the first certificate for verification C1 stored in a certificate storage 52 (see FIG. 6 and the like) in the first virtual environment 50 to perform the verification processing of the first server certificate (described later) (see also FIG. 33).

The second verification processing part 78 is a verification processing part operating in the second virtual environment 70. The second verification processing part 78 uses the second certificate for verification C2 stored in a certificate storage 72 (see FIG. 6 and the like) in the second virtual environment 70 to perform the verification processing of the second server certificate (described later).

<1-3. Plural Virtual Environments in MFP 10>

A plurality of virtual environments are constructed in the MFP 10. The plurality of virtual environments are constructed (logically divided) by sharing the hardware (processor, HDD, or the like) of the MFP 10.

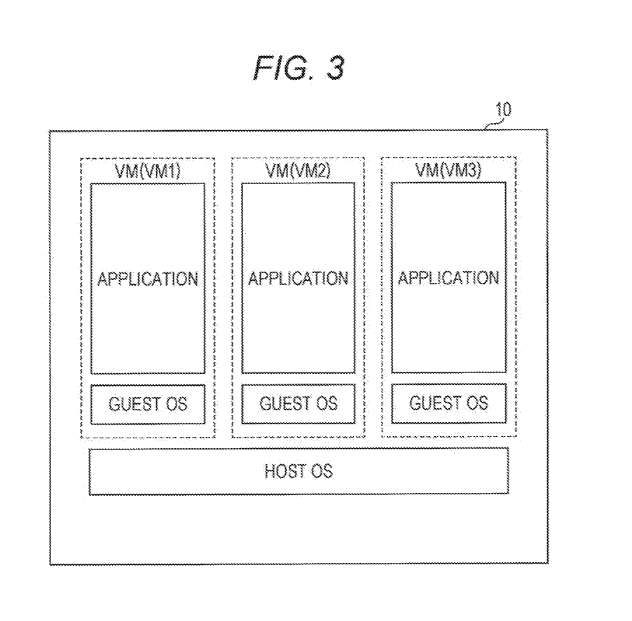

For example, a “virtual machine environment” is exemplified as a “virtual environment”. A plurality of virtual machine environments are composed of virtual machines each operating with a plurality of guest operating systems (OSs) on the same host OS. FIG. 3 is a diagram showing a plurality of virtual machine environments VM (VM1, VM2, . . . ).

As shown in FIG. 3, a plurality of guest OSs are installed on the same host OS. The plurality of virtual machine environments VM (VM 1, VM 2, . . . ) are constructed by installing application software (a server application) for service processing on each of the plurality of guest OSs.

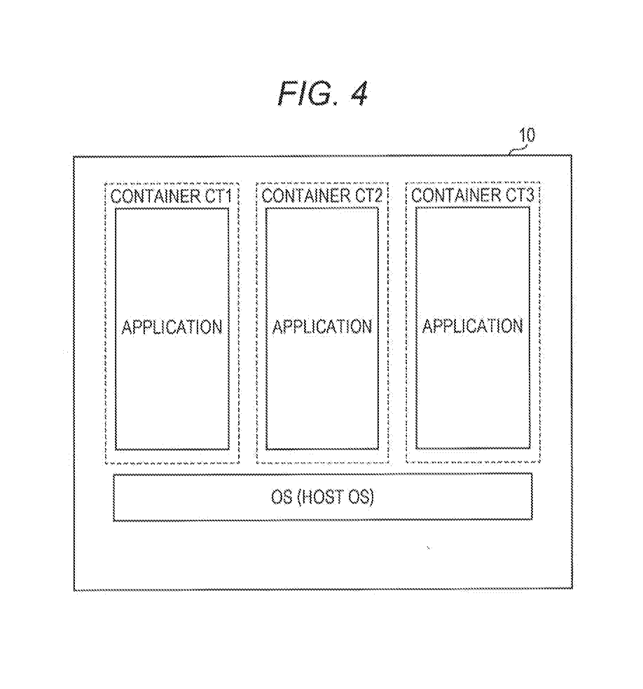

As the “virtual environment”, a “virtual container environment” is also exemplified. The plurality of virtual container environments are composed of virtual containers (also referred to as simply a container) CT (CT1, CT2, . . . ) each operating by a plurality of guest OSs on the same host OS. FIG. 4 is a diagram showing a plurality of virtual container environments.

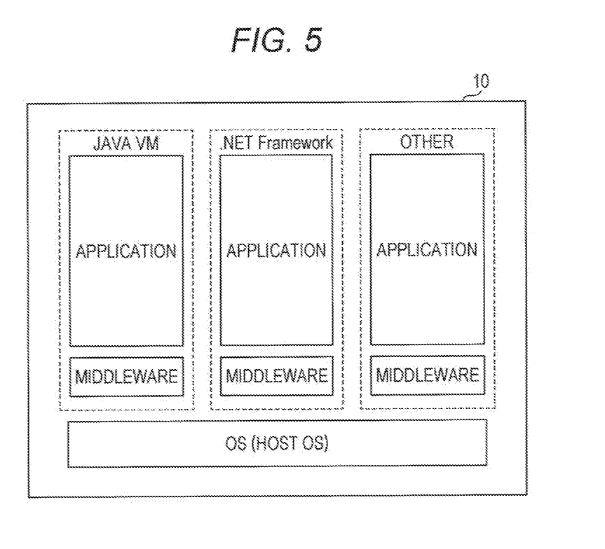

As the “virtual environment”, “a software execution environment (on middleware)” is also exemplified. The plurality of software execution environments are composed of software execution environments each operating with a plurality of pieces of middleware on the same host OS. FIG. 5 is a diagram showing a plurality of software execution environments. As shown in FIG. 5, examples of the middleware include an execution environment of a Java virtual machine (Java (registered trademark) virtual machine), a Microsoft.NET Framework, and the like.

<1-4. Program Configuration in MFP 10>

In this embodiment, two virtual environments 50, 70 are constructed in the MFP 10 as a plurality of virtual environments. A “virtual container environment” is adopted as the “virtual environment”, the first virtual environment 50 is the virtual container CT1 (see FIG. 4), and the second virtual environment 70 is the virtual container CT2.

Here, the “IWS platform virtual environment” is exemplified as a virtual environment of the first virtual environment 50 and the “operation panel virtual environment” is exemplified as the second virtual environment 70.

The “IWS platform virtual environment” is a virtual environment in which a platform for an IWS (also referred to as a server (internal web server) provided inside the MFP) is operated. The “operation panel virtual environment” is a virtual environment in which the operation panel is operated, and is a virtual environment different from the “IWS platform virtual environment”.

Then, as shown in FIG. 33, it is assumed that the first application 51 in the first virtual environment 50 performs encrypted communication with the external server 90, and a second application (browser) 71 in the second virtual environment 70 also performs encrypted communication with the external server 90.

More specifically, at the time of log-in to the external server 90, a browser (second application) 71 in the second virtual environment 70 performs SSL communication (encrypted communication) with the external server 90. In the SSL communication, first, the second application 71 receives a server certificate (also referred to as a second server certificate) from the external server 90, and performs verification processing of the server certificate. When reliability of the server certificate is confirmed, the second application 71 performs encrypted communication using a public key (and a secret key of the second virtual environment 70), or the like in the server certificate with the external server 90.

Similarly, the first application 51 in the first virtual environment 50 performs the SSL communication (encrypted communication) with the external server 90 at the time of another operation (at the time of data transmission/reception or the like). In the SSL communication, first, the first application 51 receives a server certificate (also referred to as a first server certificate) from the external server 90, and performs verification processing of the server certificate. When reliability of the server certificate is confirmed, the first application 51 performs encrypted communication using a public key (and a secret key of the first virtual environment 50), or the like in the server certificate with the external server 90.

Also, in the second application (browser) 71, display processing of a processing result (including a processing result based on communication between the external server 90 and the first application 51) in the first application 51, and the like are performed. In other words, the first application 51 and the second application 71 cooperate to operate.

<1-5. Encrypted Communication Including Verification of Server Certificate>

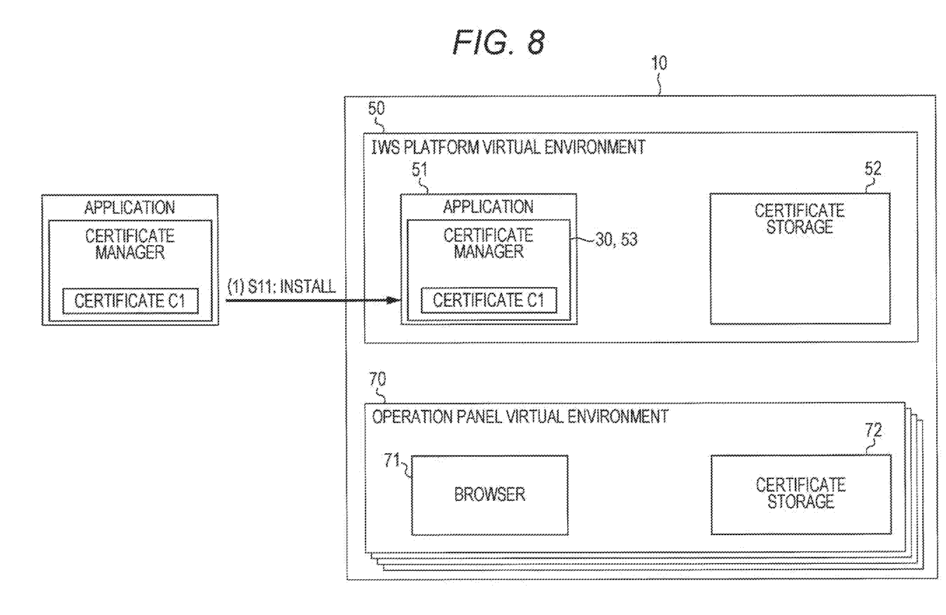

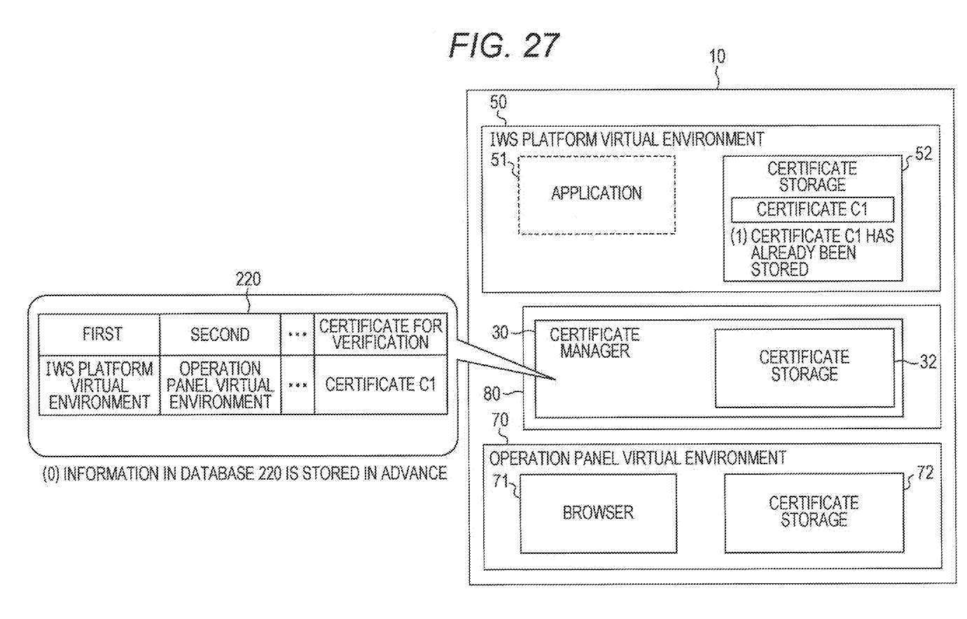

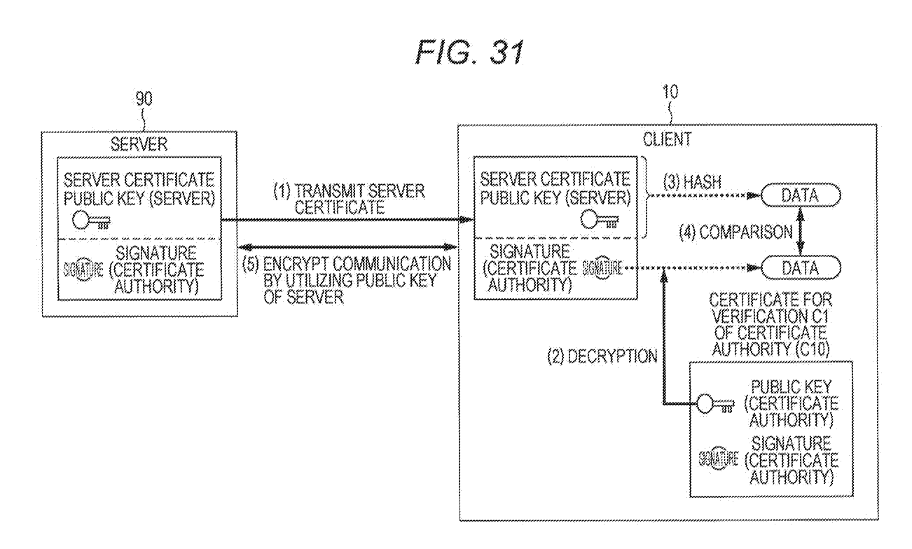

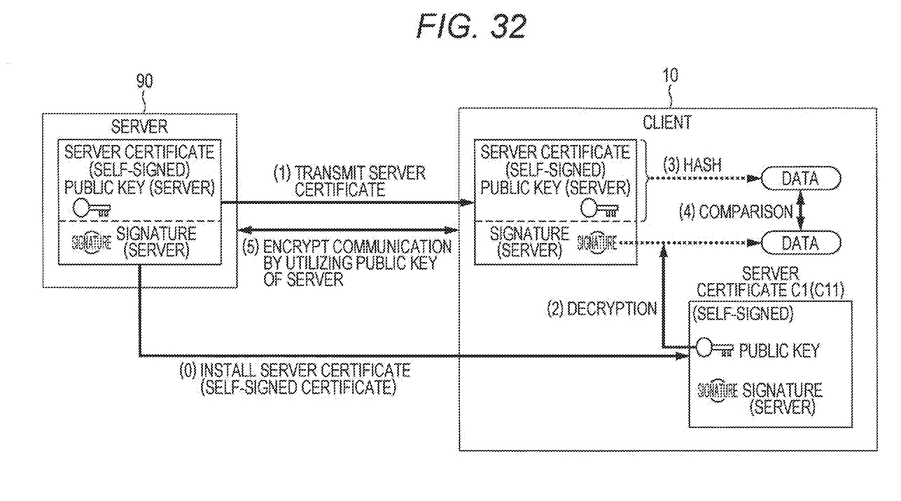

At a predetermined point of time before the SSL communication as described above is started (in other words, before the server certificate is transmitted from the external server 90), a certificate for verifying the server certificate from the external server 90 (certificate for verification (specifically, the first certificate for verification C1)) is already stored in the client device (specifically, the certificate storage 52 of the first virtual environment 50) (see FIGS. 31 and 32). For example, when the first certificate for verification C1 is a “certificate of a (trusted) certificate authority” (see FIG. 31), the certificate is often stored in the certificate storage 52 at the time of construction of the first virtual environment 50 (see also FIG. 27). When the first certificate for verification C1 is a self-signed certificate (see FIG. 32), the certificate is stored in the certificate storage 52 at a predetermined timing after the construction of the first virtual environment 50 (and before the execution of the first application 51) (see FIG. 8).

In the first embodiment, the “self-signed certificate” is adopted as the first certificate for verification C1, and after the construction of the first virtual environment 50 and at the time of the installation of the first application 51, the first certificate for verification C1 is automatically stored in the certificate storage 52. Then, it is assumed that, at approximately the same time (after the construction of the first virtual environment 50 and at the time of the installation of the first application 51), as the second certificate for verification C2 utilized by the second application 71, the first certificate for verification C1 is automatically stored in the certificate storage 72.

Thereafter, the MFP (client) 10 (specifically, the first application 51 of the first virtual environment 50) receives the server certificate (also referred to as the first server certificate) from the external server 90 (for example, 90a), in encrypted communication with the external server 90 along with the execution of the first application 51 in the first virtual environment 50 (more specifically, immediately before the encrypted communication). Upon receiving the first server certificate transmitted from the external server 90, the MFP 10 verifies the reliability of the first server certificate utilizing the certificate for verification that has already been stored. Specifically, as shown in FIG. 33, the first verification processing part 58 operating in the first virtual environment 50 uses the first certificate for verification C1 stored in the certificate storage 52 in the first virtual environment 50 to perform the verification processing of the first server certificate.

More specifically, as also shown in FIGS. 31 and 32, a hash value obtained by utilizing the public key in the server certificate (first server certificate) from the external server 90, and the a hash value obtained by utilizing the public key in the certificate for verification (the first certificate for verification C1) are compared with each other, and when the two hash values match, it is decided that the server certificate transmitted from the external server 90 is legitimate. On the other hand, when the two hash values do not match, it is decided that the server certificate is not legitimate. When it is decided that the server certificate is legitimate, thereafter, the encrypted communication utilizing the public key of the server certificate (and the secret key of the client (first virtual environment 50) side) is performed between the first application 51 and the external server 90 (specifically, the server application in the external server 90).

Similarly, the MFP (client) 10 (specifically, the second application 71 of the second virtual environment 70) receives the server certificate (also referred to as the second server certificate) from the external server 90 (for example, 90a), in encrypted communication (more specifically, immediately before the encrypted communication) with the external server 90 along with the execution of the second application 71 in the second virtual environment 70. Upon receiving the second server certificate transmitted from the external server 90, the MFP 10 verifies the reliability of the second server certificate utilizing the certificate for verification that has already been stored. Specifically, as shown in FIG. 33, the second verification processing part 78 operating in the second virtual environment 70 uses the second certificate for verification C2 stored in the certificate storage 72 in the second virtual environment 70 to perform the verification processing of the second server certificate.

More specifically, as shown in FIGS. 31 and 32, a hash value obtained by utilizing the public key in the server certificate (second server certificate) from the external server 90, and the a hash value obtained by utilizing the public key in the certificate for verification (the second certificate for verification C2) are compared with each other, and when the two hash values match, it is decided that the server certificate transmitted from the external server 90 is legitimate. On the other hand, when the two hash values do not match, it is decided that the server certificate is not legitimate. When it is decided that the server certificate is legitimate, thereafter, the encrypted communication utilizing the public key of the server certificate (and the secret key of the client (second virtual environment 70) side) is performed between the second application 71 and the external server 90 (specifically, the server application in the external server 90).

In this manner, each application of each virtual environment uses the certificate for verification stored in the certificate storage of the own virtual environment to perform verification processing of the server certificate. Specifically, the first application 51 of the first virtual environment 50 uses the certificate for verification C1 stored in the certificate storage 52 of the own virtual environment 50 to perform verification processing of the server certificate. On the other hand, the second application 71 of the second virtual environment 70 uses the certificate for verification C2 stored in the certificate storage 72 of the own virtual environment 70 to perform verification processing of the server certificate.

The second certificate for verification C2 may have the same contents as that of the first certificate for verification C1.

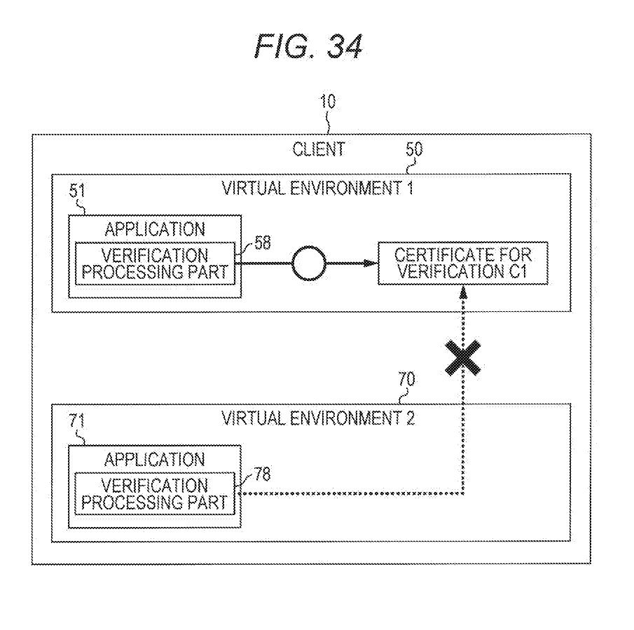

However, at the time of verification of the server certificate, each application of each virtual environment cannot refer to the certificate for verification stored in the certificate storage in other virtual environments. For example, as shown in FIG. 34, the second application 71 (second verification processing part 78) of the second virtual environment 70 cannot refer to the first certificate for verification C1 stored in the certificate storage 52 of the first virtual environment 50 to perform the verification processing of the server certificate.

In other words, in each of the plurality of virtual environments, only the certificate for verification stored (independently) in the storage of the own virtual environment can be used as the certificate for verification for verifying the server certificate transmitted from the external server in the encrypted communication with the external server along with the execution of the application in the own virtual environment.

In such a situation, when a task of storing the certificate for verification for the external server 90 in the certificate storage for each virtual environment is required as described above, considerable labor is required.

Therefore, in the present embodiment, description will be given of a technique in which the certificate for verification C1 utilized in one virtual environment 50 is also automatically stored in the certificate storage in another virtual environment 70.

<1-6. Management of Certificate for Verification>

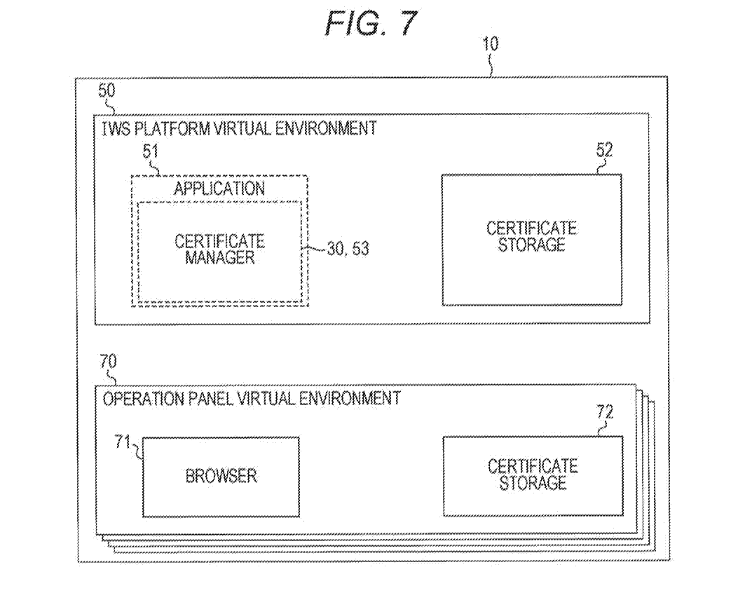

FIG. 7 shows a state in which the first virtual environment 50 and the second virtual environment 70 are constructed in the MFP 10. In FIG. 7, the first application 51 has not yet been installed in the first virtual environment 50, and the certificate for verification has not yet been stored in the certificate storage 52 of the first virtual environment 50. In addition, although the second application 71 has already been installed in the second virtual environment 70, the certificate for verification has not yet been stored in the certificate storage 72 of the second virtual environment 70. Although the certificate storage 72 is a storage capable of storing the second certificate for verification C2, the second certificate for verification C2 has not yet been stored at this time.

Description will be given below for operation of automatically storing each of the certificates for verification C1, C2 for the external server 90 in the certificate storage in each of the virtual environments 50, 70 (particularly, 70), prior to the time point in which the server certificate is transmitted from the external server 90. More specifically, a mode will be described with reference to FIGS. 6 and 8 to 11 and the like, in which, in the installation of the first application 51, the first certificate for verification C1 for the first virtual environment 50 is automatically stored in the certificate storage 52 of the first virtual environment 50, and the second certificate for verification C2 for the second virtual environment 70 is also automatically stored in the certificate storage 72 of the second virtual environment 70.

FIGS. 8 to 10 are diagrams sequentially showing states at each time point after the state of FIG. 7. FIG. 6 is a diagram collectively showing the state transitions of FIGS. 7 to 10, and FIG. 11 is a timing chart showing such operation.

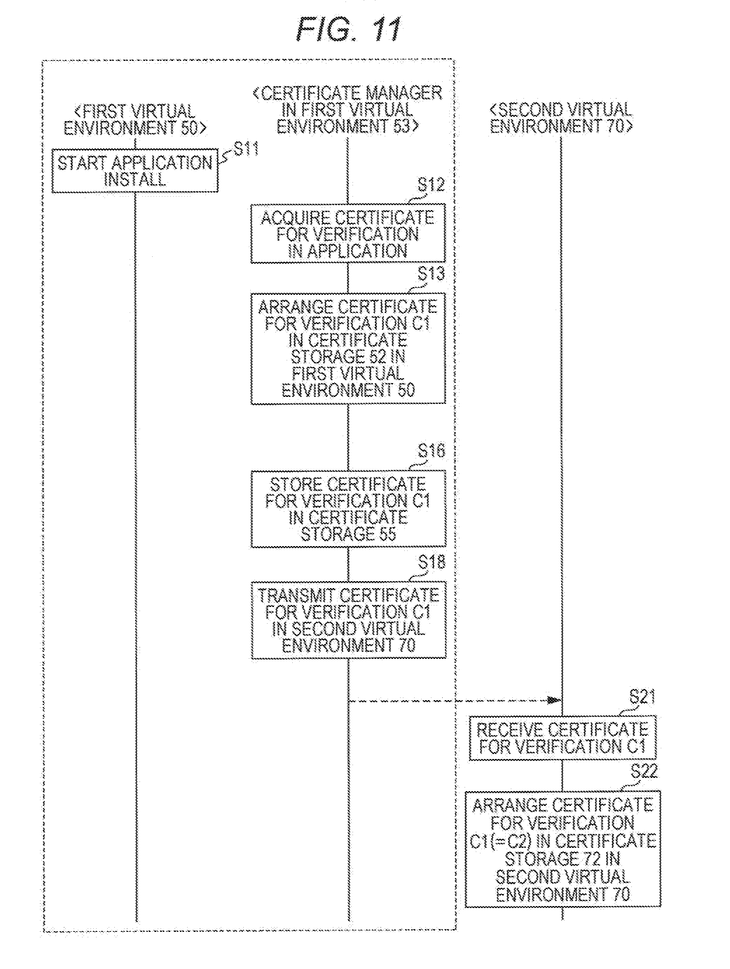

First, in step S11 (see FIG. 11), an installer of the first application 51 is activated in the first virtual environment 50, and the installation of the first application 51 is started (see also FIG. 8). Here, a module (software module) for managing the certificate is also installed during the installation, and the module (certificate management module) realizes the function of the certificate manager 30.

It is assumed that the certificate for verification C1 is embedded in data for the installation of the first application 51.

In step S12, in the installation of the first application 51, the certificate manager 30 (also referred to as 53) in the first virtual environment 50 acquires the certificate for verification C1 embedded in the data for the installation of the first application 51.

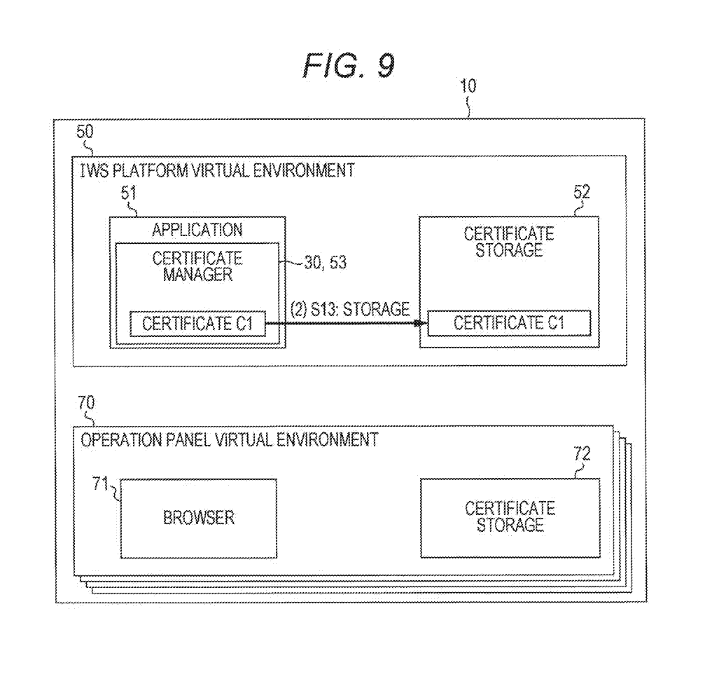

The certificate manager 30(53) stores the acquired certificate for verification C1 in the certificate storage 52 in the first virtual environment 50 (step S13) (see also FIG. 9).

The certificate manager 30(53) stores the acquired certificate for verification C1 in the certificate storage 55 (see FIG. 6) in the first virtual environment 50 (step S16). The certificate storage 55 is also referred to as a storage under the management of the certificate manager 53.

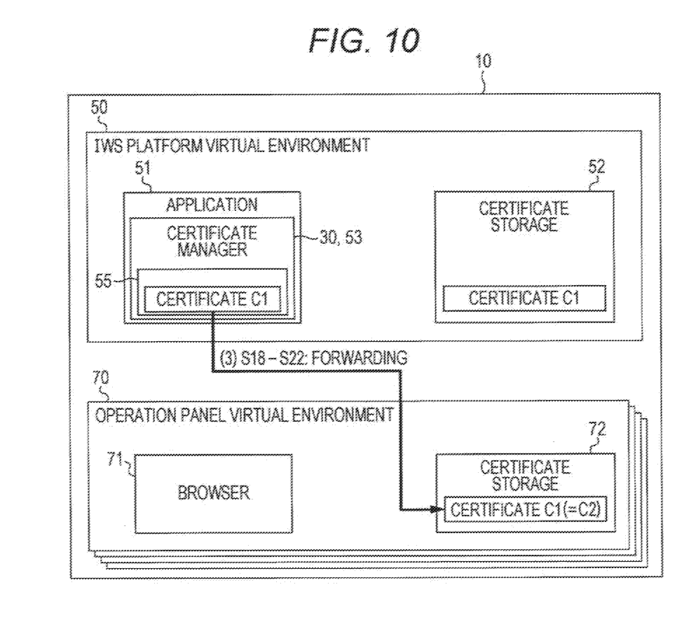

The certificate manager 30(53) of the first virtual environment 50 transmits the acquired certificate for verification C1 (specifically, a copy of the certificate for verification C1) to the second virtual environment 70 (specifically, the certificate storage 72 of the second virtual environment 70) (step S18) (see also FIG. 10).

Upon receiving the certificate for verification C1 transmitted from the first virtual environment 50 (step S21), the second virtual environment 70 stores the certificate for verification C1 in the certificate storage 72 in the second virtual environment 70, as the certificate for verification C2 (step S22). The “communication (transmission and/or reception)” in the present application may include communication between a plurality of different virtual environments, communication between different processes in the same virtual environment (interprocess communication), and the like.

In this way, the first certificate for verification C1 for the first virtual environment 50 for the external server 90 is automatically stored in the second virtual environment 70 (certificate storage 72), as the second certificate for verification C2 for the second virtual environment 70 for the external server 90. As a result, before the time point in which the server certificate is actually transmitted (the execution time point of the applications 51, 71), each of the certificates for verification C1, C2 for the external server 90 is stored in the certificate storage in each of the virtual environments 50, 70 (particularly, 70).

Thereafter, in the reception of the server certificate (first server certificate) from the external server 90 along with the execution of the first application 51, the verification processing of the server certificate is performed by using the first certificate for verification C1 in the first virtual environment 50. In the reception of the server certificate (second server certificate) from the external server 90 along with the execution of the second application 71, the verification processing of the server certificate is performed by using the second certificate for verification C2 in the second virtual environment 70.

<1-7. Effect in First Embodiment>

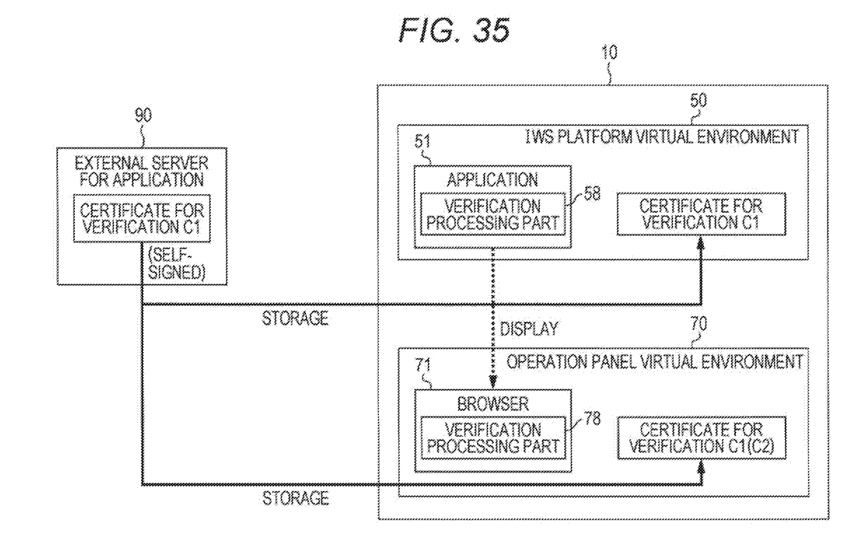

According to the above embodiment, in the installation of the first application 51, the first certificate for verification C1 embedded in the installation data of the first application 51 is acquired by the certificate manager 30(53) in the first virtual environment 50 (step S12). Then, the certificate manager 30 automatically stores the first certificate for verification C1 in the certificate storage 72 in the second virtual environment 70, as the second certificate for verification C2 (steps S18 to S22). Therefore, it is not necessary to separately perform the operation (see FIG. 35) of storing the second certificate for verification C2 for the second virtual environment 70 in the certificate storage 72 in the second virtual environment 70. Therefore, it is possible to perform management of a certificate for verification in a plurality of virtual environments relatively easily, in an information processing apparatus that constructs the plurality of virtual environments.

The above embodiment is particularly useful when the “self-signed certificate” is utilized as the certificate for verification. However, the present invention is not limited to this, and is useful also in the case where the “certificate for verification by a trusted certificate authority” is utilized as the certificate for verification (this is similar in other embodiments).

For example, the present invention is useful also in the case where the “certificate for verification by a trusted certificate authority” has not yet been stored in the second virtual environment 70 (specifically, the certificate storage 72 thereof) for some reason. In this case, when a task (see FIG. 35) of storing the second certificate for verification C2 for the second virtual environment 70 in the certificate storage 72 in the second virtual environment 70 is additionally required, management of the certificate for verification related to the server certificate becomes complicated.

On the other hand, according to the above embodiment, even when the “certificate for verification by a trusted certificate authority” (the second certificate for verification C2) has not yet been stored in the second virtual environment 70 at the time of the construction of the second virtual environment 70, the first certificate for verification C1 is automatically stored in the second virtual environment 70, as the second certificate for verification C2 at the time of the installation of the first application 51. Therefore, it is possible to perform management of a certificate for verification in a plurality of virtual environments relatively easily.

### 2. Second Embodiment

In the first embodiment, the certificate manager 30 is provided in the first virtual environment (IWS platform virtual environment), but the present invention is not limited to this, and the certificate manager 30 may be provided in a virtual environment other than the first virtual environment (for example, a third virtual environment, the second virtual environment, or the like).

The second embodiment is a modification of the first embodiment. In this second embodiment, a mode in which the certificate manager 30 is provided in the third virtual environment will be described focusing on differences from the first embodiment.

Also in the second embodiment, description will be made from the state of FIG. 7. As described above, in the state shown in FIG. 7, the certificate for verification has not yet been stored in the certificate storage 52 of the first virtual environment 50, and the certificate for verification also has not yet been stored in the certificate storage 72 of the second virtual environment 70. Although the certificate storage 72 is a storage capable of storing the second certificate for verification C2, the second certificate for verification C2 has not yet been stored at this time.

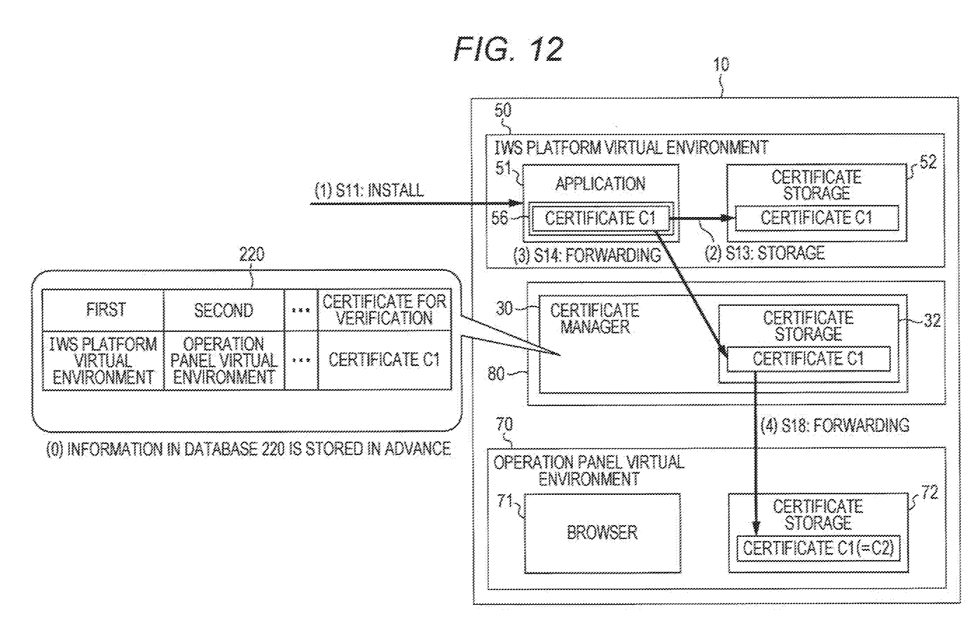

A mode will be described below with reference to FIGS. 12 to 16 or the like, in which, in the installation of the first application 51, the first certificate for verification C1 for the first virtual environment 50 is automatically stored in the certificate storage 52 of the first virtual environment 50, and the first certificate for verification C1 (as the second certificate for verification C2 for the second virtual environment 70) is automatically stored also in the certificate storage 72 of the second virtual environment 70 by using the certificate manager 30 in the third virtual environment.

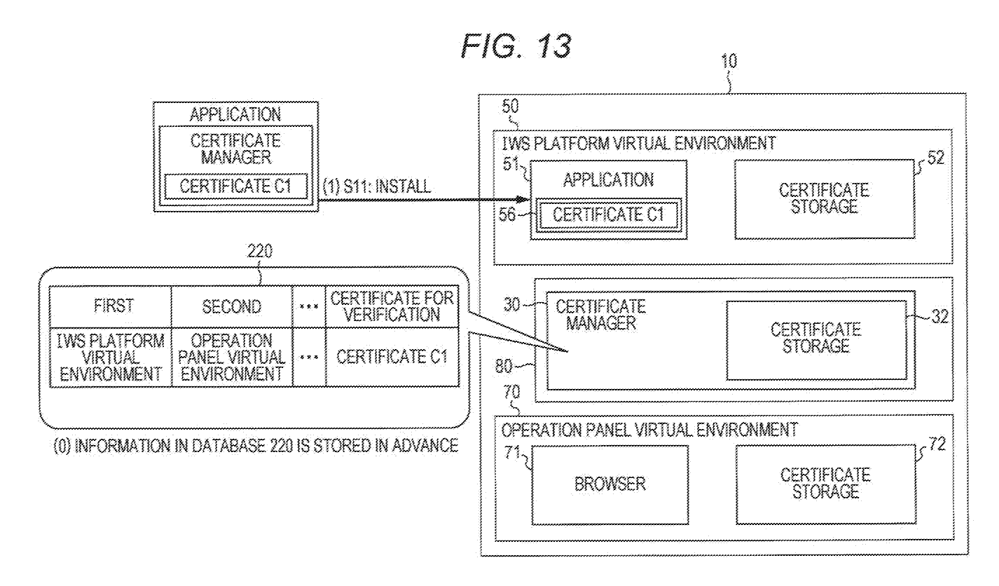

FIGS. 13 to 15 are diagrams sequentially showing states at each time point after the state of FIG. 7. FIG. 12 is a diagram collectively showing the state transitions of FIGS. 7 and 13 to 15, and FIG. 16 is a timing chart showing such operation.

First, the operation of step S11 (S11b) is performed. Specifically, the installer of the first application 51 is activated in the first virtual environment 50, and the installation of the first application 51 is started (see FIG. 13).

Here, a module for managing the certificate is also installed during the installation, and the module realizes the function of a forwarding processing part 56. It is assumed that the certificate for verification C1 is embedded in data for the installation of the first application 51.

Next, in step S12(S12b), in the installation of the first application 51, the forwarding processing part 56 in the first virtual environment 50 acquires the certificate for verification C1 embedded in the data for the installation of the first application 51.

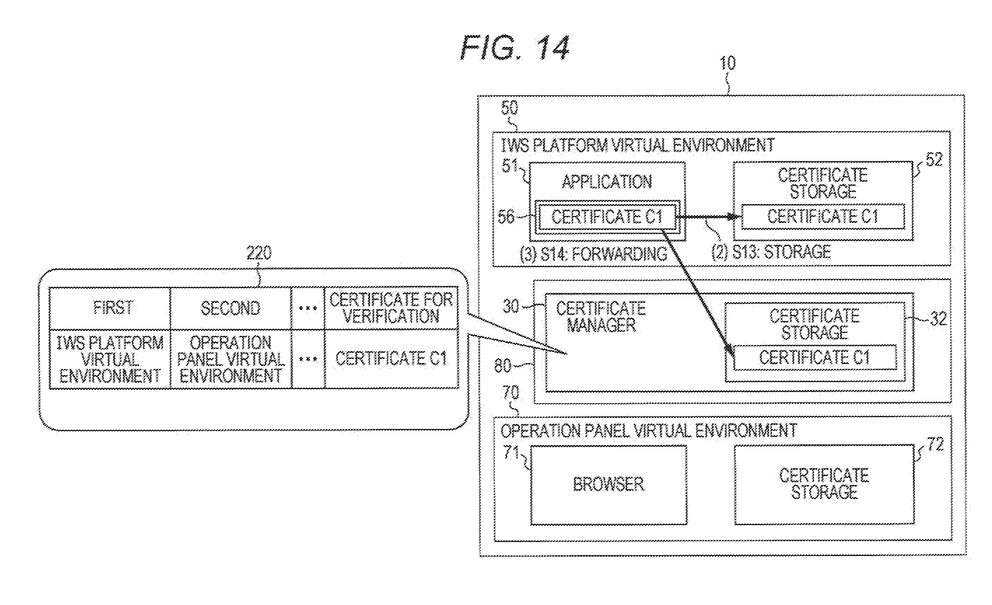

Then, the forwarding processing part 56 stores the acquired certificate for verification C1 (specifically, a copy of the certificate for verification C1) in the certificate storage 52 in the first virtual environment 50 (step S13b) (see FIG. 14).

The certificate for verification C1 is stored in the certificate storage 72 of the second virtual environment 70 via the third virtual environment 80 (steps S14 to S22).

Specifically, first, the forwarding processing part 56 forwards (transmits) the acquired certificate for verification C1 to the certificate manager 30 in the third virtual environment 80 (specifically, the certificate storage 32 under the management of the certificate manager 30 (see FIG. 14)) (step S14).

Next, upon receiving the certificate for verification C1 transmitted from the first virtual environment 50 (step S15), the certificate manager 30 stores the certificate for verification C1 in the certificate storage 32 in the third virtual environment 80 (step S16b).

Then, the certificate manager 30 determines the transmission destination of the certificate for verification C1 on the basis of a database 220 (step S17). In the third virtual environment 80, a predetermined application program has been installed, and the function of the certificate manager 30 is realized with the predetermined application program. It is assumed that the database 220 is also constructed in the third virtual environment 80 in advance by the installation of the predetermined application program. In the database 220, a virtual environment that utilizes each certificate for verification is defined in advance. Specifically, it is defined in advance that the first certificate for verification C1 is utilized in the first virtual environment 50 and the second virtual environment 70.

Here, in step S17, the explanation will be continued assuming that the second virtual environment 70 has been determined as the transmission destination of the certificate for verification C1.

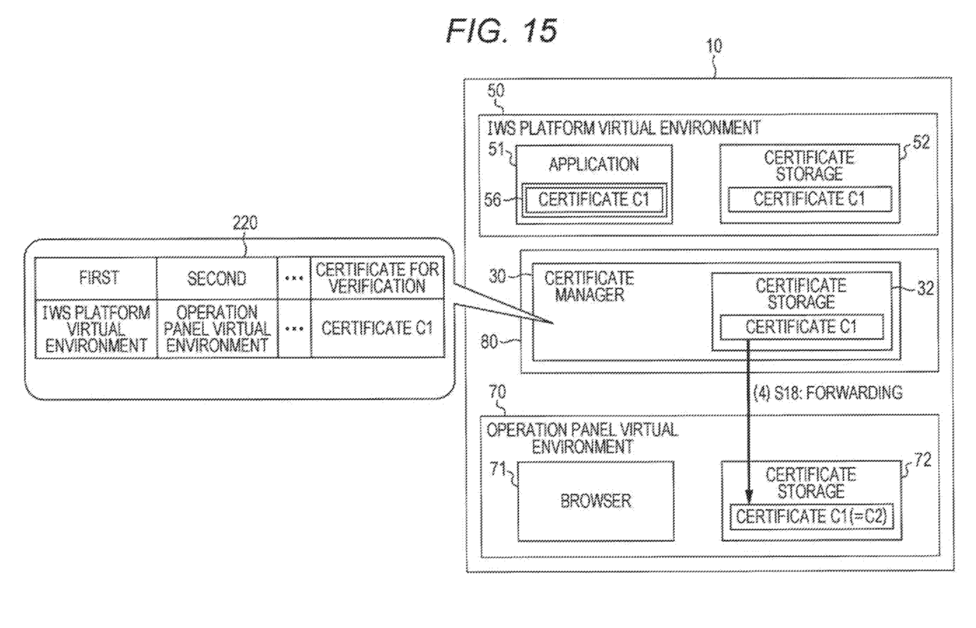

In next step S18b, the certificate manager 30 transmits the acquired certificate for verification C1 (specifically, a copy of the certificate for verification C1) to the second virtual environment 70 (specifically, the certificate storage 72 of the second virtual environment 70) (step S18) (see also FIG. 15).

Upon receiving the certificate for verification C1 transmitted from the certificate manager 30 of the third virtual environment 80 (step S21b), the second virtual environment 70 stores the certificate for verification C1 in the certificate storage 72 in the second virtual environment 70, as the certificate for verification C2 (step S22b).

In this way, the first certificate for verification C1 for the first virtual environment 50 for the external server 90 is transmitted to the second virtual environment 70 via the certificate manager 30 and automatically stored in the second virtual environment 70 (certificate storage 72), as the second certificate for verification C2 for the second virtual environment 70 for the external server 90. As a result, before the time point in which the server certificate is actually transmitted (the execution time point of the applications 51, 71), each of the certificates for verification C1, C2 for the external server 90 is stored in the certificate storage in each of the virtual environments 50, 70 (particularly, 70).

Thereafter, in the reception of the server certificate (first server certificate) from the external server 90 along with the execution of the first application 51, the verification processing of the server certificate is performed by using the first certificate for verification C1 in the first virtual environment 50. In the reception of the server certificate (second server certificate) from the external server 90 along with the execution of the second application 71, the verification processing of the server certificate is performed by using the second certificate for verification C2 (specifically, the first certificate for verification C1 stored in the certificate storage 72 as the second certificate for verification C2) in the second virtual environment 70.

Thereby, as similar to the first embodiment, it is possible to perform management of a certificate for verification in a plurality of virtual environments relatively easily.

In the second embodiment, the forwarding processing part 56 stores the first certificate for verification C1 in the certificate storage 52 (step S13), but the present invention is not limited to this, and for example, immediately after step S17, the certificate manager 30 may store the first certificate for verification C1 in the certificate storage 52.

In the second embodiment, the certificate manager 30 is provided in the third virtual environment 80, but the present invention is not limited to this, and the certificate manager 30 may be provided in the second virtual environment 70 or the like.

### 3. Third Embodiment

A third embodiment is a modification of the second embodiment and the like. Description will be given below mainly for differences from the second embodiment.

In each of the above embodiments, a mode is exemplified in which the first certificate for verification C1 is stored in the second virtual environment 70, as the second certificate for verification C2 in the installation of the first application 51.

In the third embodiment, a mode is exemplified in which the first certificate for verification C1 is stored in the second virtual environment 70, as the second certificate for verification C2 in the update of the second virtual environment 70 (otherwise, the update of the second application 71).

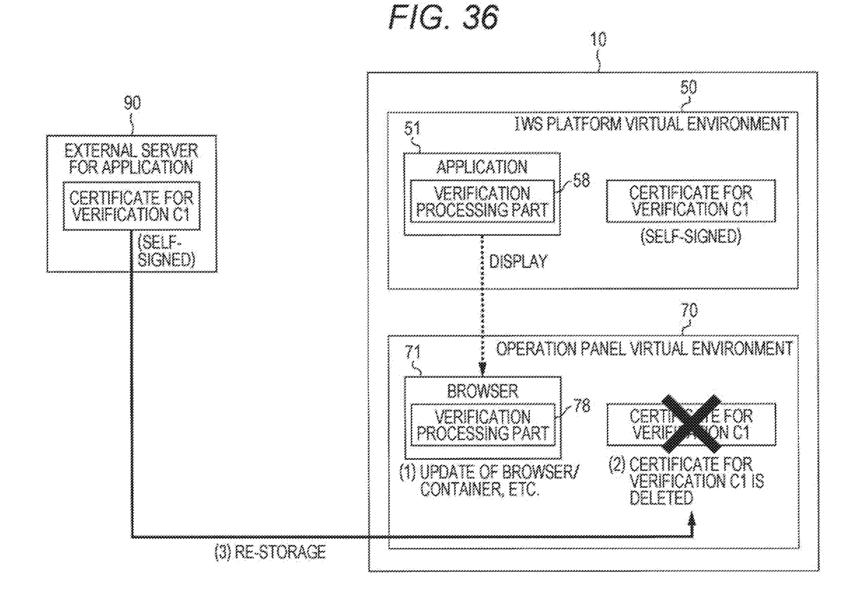

Each virtual environment and/or each application is updated in some cases. For example, as shown in FIG. 36, updating of the second virtual environment 70 (otherwise updating of the second application 71) is performed in some cases. At this time, the second certificate for verification C2 is deleted due to some circumstances in some cases. In such a situation, conventionally, it has been required that the user (end user or administrative user) performs the task of storing the second certificate for verification C2 again. FIG. 36 is a diagram showing operation according to such a comparative example.

On the other hand, in the third embodiment, immediately after the updating of the second virtual environment 70, the first certificate for verification C1 (in other words, the same certificate as the first certificate for verification C1) is automatically stored in the certificate storage 72 in the second virtual environment 70 as the second certificate for verification C2. More specifically, the first certificate for verification C1 stored in the same virtual environment (third virtual environment 80) as the virtual environment (third virtual environment 80) in which the certificate manager 30 is provided is automatically stored in the certificate storage 72 in the second virtual environment 70 as the second certificate for verification C2. Such a mode will be described below.

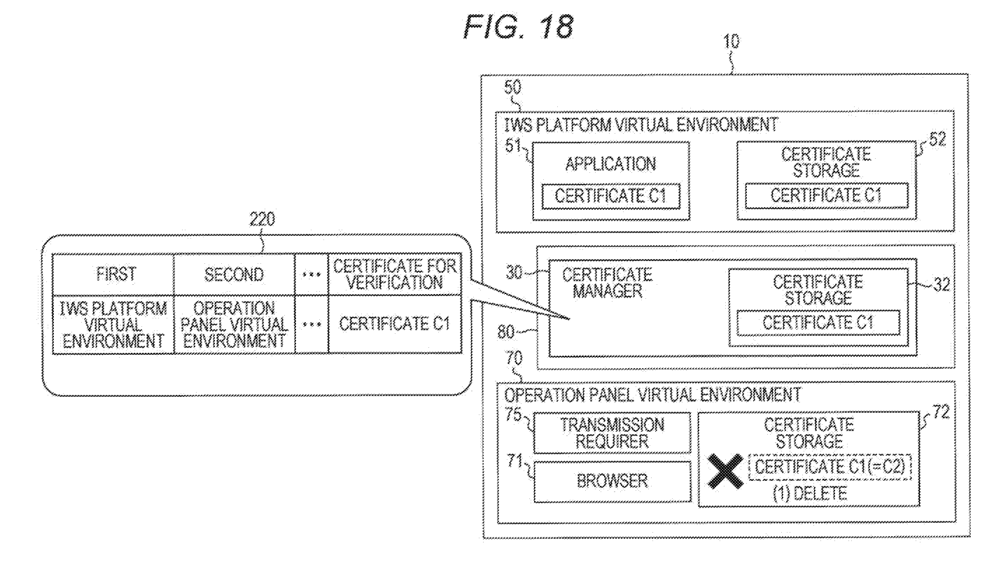

In the third embodiment, description will be made from the state of FIG. 18. FIG. 18 is a diagram showing a state immediately after the updating of the second virtual environment 70. FIG. 18 shows a state where, immediately after the updating of the second virtual environment 70, the second certificate for verification C2 is deleted from the second virtual environment 70 (in detail, the certificate storage 72) due to the updating. Although the certificate storage 72 is a storage capable of storing the second certificate for verification C2, the second certificate for verification C2 has not been stored at this time.

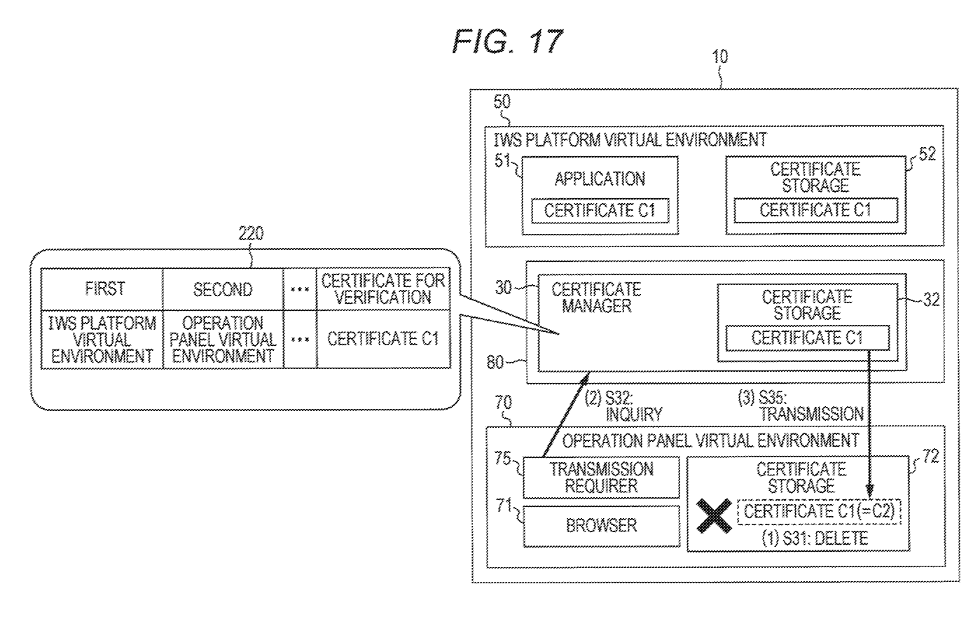

A mode will be described below with reference to FIGS. 17 to 21 and the like, in which, immediately after the updating of the second virtual environment 70, the first certificate for verification C1 is automatically stored in the certificate storage 72 of the second virtual environment 70 as the second certificate for verification C2 for the second virtual environment 70, by using the certificate manager 30 in the third virtual environment 80.

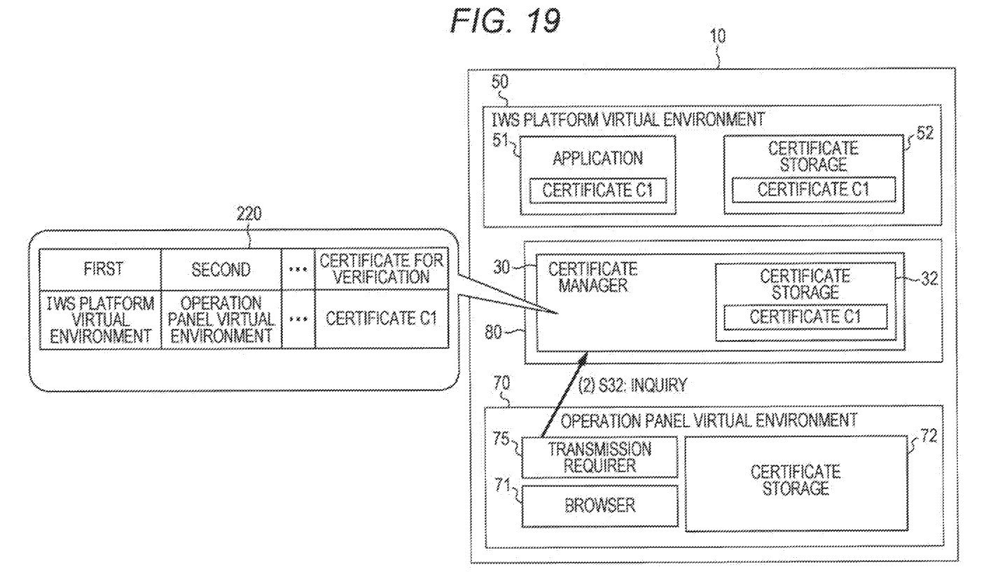

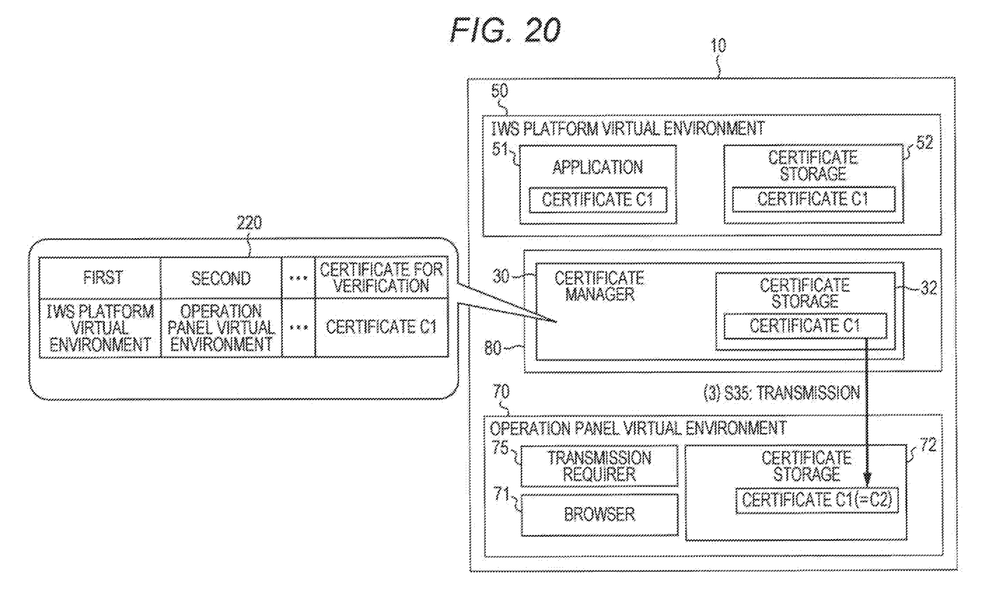

FIGS. 19 and 20 are diagrams sequentially showing states at each time point after the state of FIG. 18. FIG. 17 is a diagram collectively showing the state transitions of FIGS. 18 to 20, and FIG. 21 is a timing chart showing such operation.

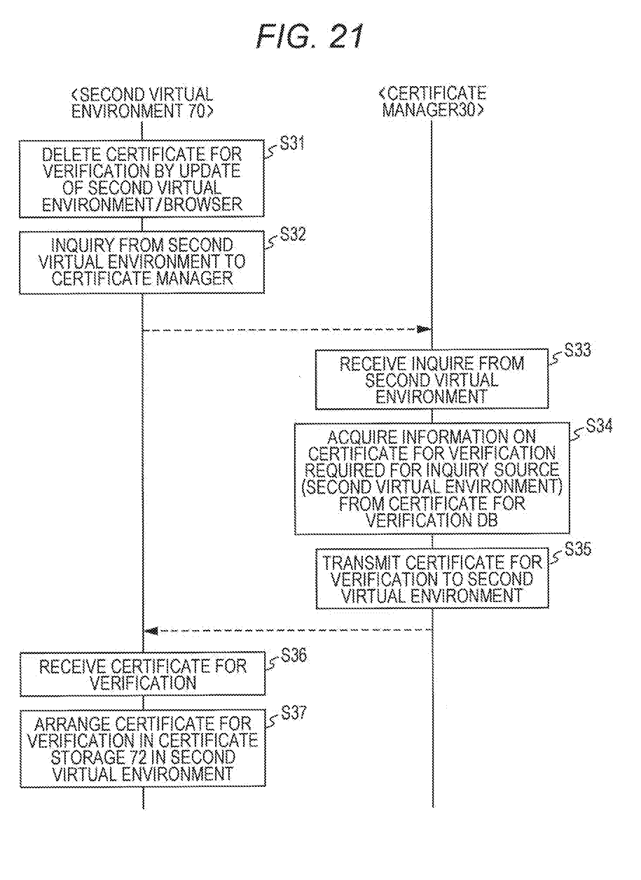

First, in step S31 (FIG. 21), update processing of the second virtual environment 70 is performed. Here, it is assumed that the second certificate for verification C2 is deleted along with the update processing (see also FIG. 18).

In next step S32, inquiry is made for the certificate for verification to be stored in the second virtual environment 70 from the second virtual environment 70 to the certificate manager 30 (see FIG. 19). Specifically, a transmission requirer 75 in the second virtual environment 70 imparts a transmission requirement of the certificate for verification to be stored in the second virtual environment 70, to the certificate manager 30. It is assumed that a predetermined module has already been installed along with the installation of the second application 71, and the predetermined module realizes the function of the transmission requirer 75. Further, it is assumed that the predetermined module operates also after the update processing of the second virtual environment 70.

Upon receiving the inquiry (transmission requirement) from the second virtual environment 70 (step S33), the certificate manager 30 acquires the certificate for verification to be stored in the second virtual environment 70 (for example, the first certificate for verification C1) from the certificate storage 32 in the third virtual environment 80 (step S34). Then, the certificate manager 30 transmits the acquired certificate for verification (first certificate for verification C1) to the second virtual environment 70 (step S35).

In the second virtual environment 70, when the certificate for verification (the first certificate for verification C1) is received from the certificate manager 30 (step S36), the certificate for verification is stored in the certificate storage 72 in the second virtual environment 70 (step S37).

When there are a plurality of certificates (a plurality of certificates for verification for a plurality of different external servers 90) as certificates for verification to be stored in the second virtual environment 70, it is sufficient that all of the plurality of certificates are transmitted from the certificate manager 30 to the second virtual environment 70, and stored in the certificate storage 72. When a part (or all) of the plurality of certificates has already been stored in the certificate storage 72, it is sufficient that the part (or all) of the plurality of certificates is overwritten and stored. Alternatively, only the certificate for verification that does not exist in the certificate storage 72 at that time may be stored (in other words, overwrite storage may not be performed).

In this way, in response to the inquiry from the second virtual environment 70, the certificate for verification (first certificate for verification C1) for the second virtual environment 70 for the external server 90 is transmitted to the second virtual environment 70 from the certificate manager 30 and automatically stored in the second virtual environment 70 (certificate storage 72), as the second certificate for verification C2 for the second virtual environment 70 for the external server 90. As a result, before the time point in which the server certificate is actually transmitted (the execution time point of the second application 71) after the updating of the second virtual environment 70, the certificate for verification (first certificate for verification C1) for the external server 90 is stored in the certificate storage in the second virtual environment 70.

Thereafter, in the reception of the server certificate from the external server 90 along with the execution of the second application 71, the verification processing of the server certificate is performed by using the certificate for verification C2 (certificate for verification C1) in the second virtual environment 70.

Thereby, as similar to the first embodiment, it is possible to perform management of a certificate for verification in a plurality of virtual environments relatively easily.

### Modification of Third Embodiment

In the third embodiment, the first certificate for verification C1 is stored in the second virtual environment 70 by the certificate manager 30 in the third virtual environment 80, but the present invention is not limited to this, and the first certificate for verification C1 may be stored in the second virtual environment 70 by the certificate manager in the other virtual environment. For example, the certificate manager 30(53) in the first virtual environment 50 may store the first certificate for verification C1 in the second virtual environment 70. In this case, it is sufficient that the transmission requirer 75 (FIG. 19) imparts a transmission requirement of the certificate for verification to be stored in the second virtual environment 70, to the certificate manager 53 in the first virtual environment 50. Then, it is sufficient that, in response to the transmission requirement (inquiry) from the second virtual environment 70, the certificate manager 53 transmits the first certificate for verification C1 acquired from the certificate storage 52 in the first virtual environment 50 to the second virtual environment 70.

In this way, it is sufficient that the first certificate for verification C1 stored in the same virtual environment (first virtual environment 50, third virtual environment 80, or the like) as the virtual environment in which the certificate manager 30 is provided is automatically stored in the certificate storage 72 in the second virtual environment 70 as the second certificate for verification C2.

In the third embodiment, the above operation is performed immediately after the updating of the second virtual environment 70, but the present invention is not limited to this and, similar operation to the above-described operation may be performed immediately after the updating of the second application 71.

In the third embodiment, the first certificate for verification C1 is stored in the second virtual environment 70 as the second certificate for verification C2 in the updating of the second virtual environment 70 or the like.

However, the present invention is not limited to this. In restoration processing (described below) using backup data of the second virtual environment 70, the first certificate for verification C1 may be stored in the second virtual environment 70, as the second certificate for verification C2.

Here, restoration is performed by using backup data (backup image data) of each virtual environment, in some cases. In the backup processing of virtual environment, although almost all of the virtual environment is regarded as the backup target data, some data (for example, certificate for certificate) is excluded in some cases. When such restoration processing (restoration processing of a virtual environment) utilizing backup data is performed, some data (certificate for verification or the like) does not exist in the restored virtual environment in some cases. In such a situation, conventionally, it has been required that the user (end user or administrative user) performs the task of storing the second certificate for verification C2 (and the first certificate for verification C1) again.

On the other hand, similar operation (steps S32 to S37 (see FIG. 21)) to the third embodiment may be performed immediately after the restoration processing using the backup data of each virtual environment is performed. Thereby, the certificate for verification (first certificate for verification C1) for the second virtual environment 70 for the external server 90 is transmitted to the second virtual environment 70 from the certificate manager 30 and automatically stored in the second virtual environment 70 (certificate storage 72), as the second certificate for verification C2 for the second virtual environment 70 for the external server 90, so that a similar effect to that of the third embodiment can be obtained.

### 4. Fourth Embodiment

A fourth embodiment is a modification of the second embodiment and the like. Description will be given below mainly for differences from the second embodiment.

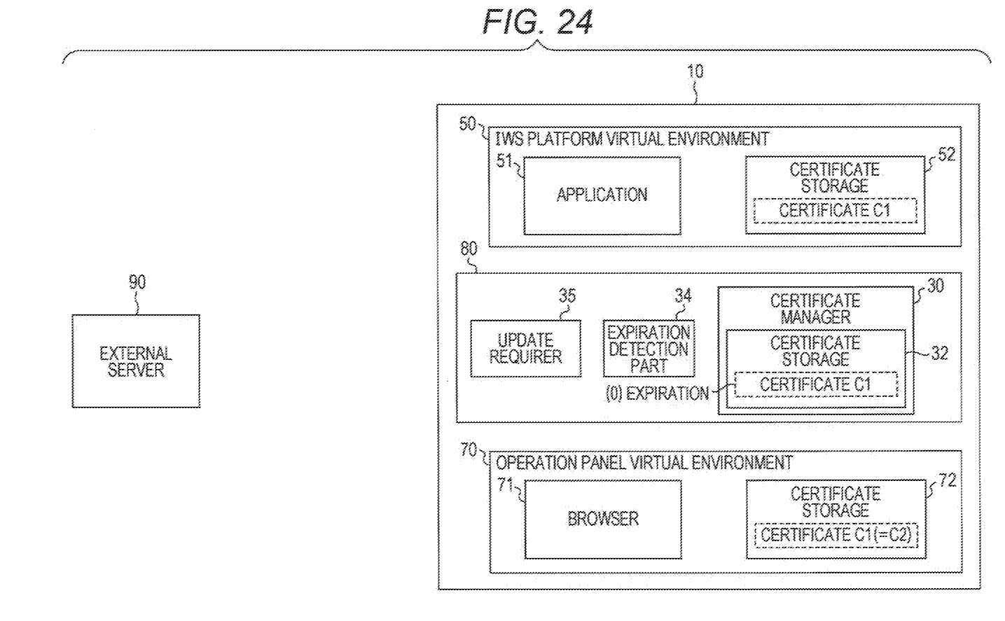

In the fourth embodiment, a mode is exemplified in which, when the expiration of the first certificate for verification C1 has occurred (see FIG. 24), a new first certificate for verification C1 is acquired, and the new first certificate for verification C1 is stored in the second virtual environment 70 as the second certificate for verification C2. The new first certificate for verification C1 is also stored in the first virtual environment 50.

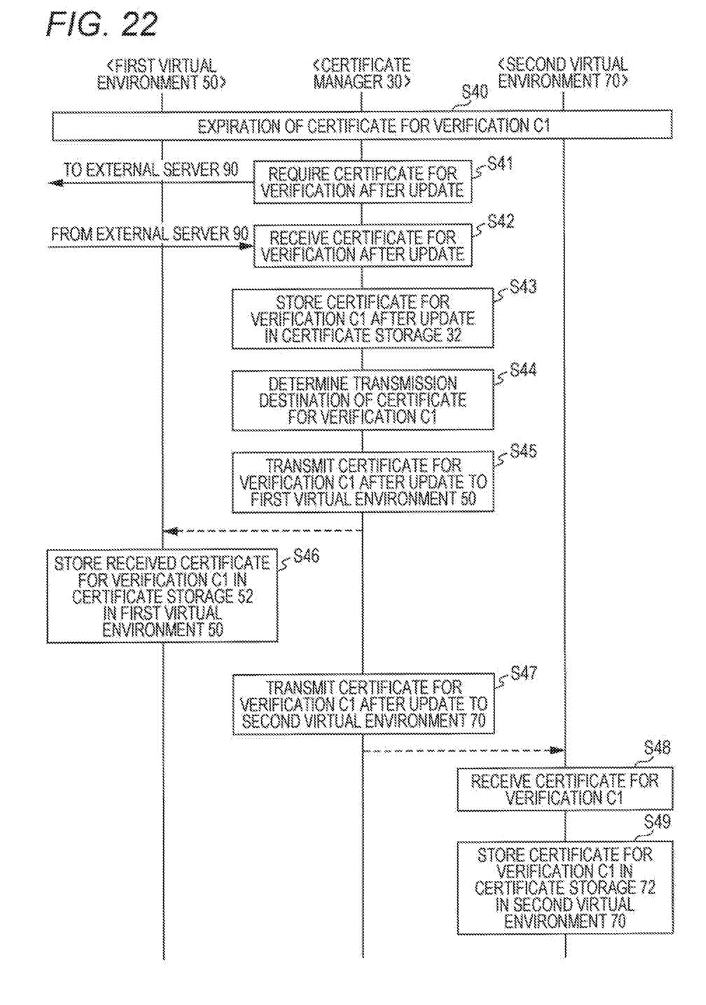

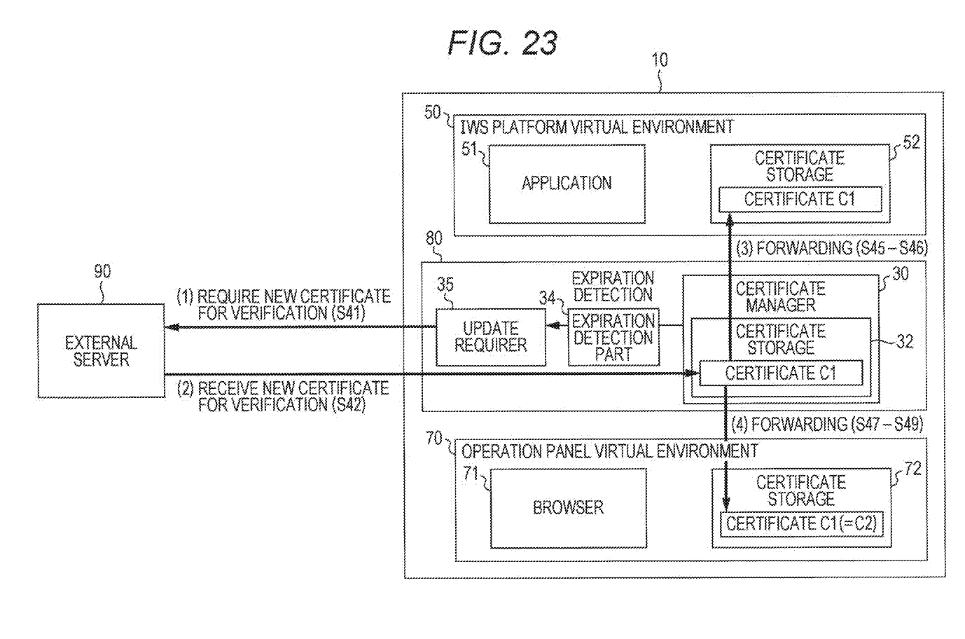

Hereinafter, description will be made with reference to FIGS. 22 and 23. FIG. 22 is a timing chart showing the operation according to the fourth embodiment. FIG. 23 is a conceptual diagram showing the operation according to the fourth embodiment.

When the expiration of the first certificate for verification C1 (step S40 (FIG. 22)) occurs at one time point (see also FIG. 24), an expiration detection part 34 cooperates with the certificate manager 30, and detects the expiration (see also FIG. 23). When the expiration detection part 34 detects the expiration, the update requirer 35 transmits an update requirement of the first certificate for verification C1 to the external server 90 (step S41). The expiration detection part 34 and the update requirer 35 are processing parts realized by a program (module) installed in the third virtual environment 80.

When the first certificate for verification C1 after being updated that has been sent back in response to the update requirement from the update requirer 35 is received by the third virtual environment 80 (the certificate manager 30 or the like) (step S42), the certificate manager 30 stores the updated first certificate for verification C1 in the certificate storage 32 in the third virtual environment 80 (step S43).

Thereafter, the certificate manager 30 determines the transmission destination of the certificate for verification C1 on the basis of a database 220 (step S44). Here, in step S44, it is assumed that the first virtual environment 50 and the second virtual environment 70 have been determined as the transmission destinations of the certificate for verification C1.

The certificate manager 30 transmits the first certificate for verification C1 after being updated to the first virtual environment 50 (step S45), and stores the first certificate for verification C1 in the certificate storage 52 in the first virtual environment 50 (step S46).

The certificate manager 30 transmits the first certificate for verification C1 after being updated to the second virtual environment 70 (step S47, S48), and stores the first certificate for verification C1 in the certificate storage 72 in the second virtual environment 70 (step S49).

According to the operation as described above, immediately after the expiration of the first certificate for verification C1, the first certificate for verification C1 is automatically stored in the certificate storage 72 in the second virtual environment 70, as the second certificate for verification C2. The first certificate for verification C1 is also automatically stored in the certificate storage 52 in the first virtual environment 50. Therefore, it is possible to perform management of a certificate for verification in a plurality of virtual environments relatively easily.

In the fourth embodiment, the expiration detection part 34 in the third virtual environment 80 detects the expiration of the first certificate for verification C1, the update requirer 35 in the third virtual environment 80 transmits the update requirement of the first certificate for verification C1 to the external server 90, and the certificate manager 30 in the third virtual environment 80 acquires the first certificate for verification C1 after being updated. However, the present invention is not limited to this.

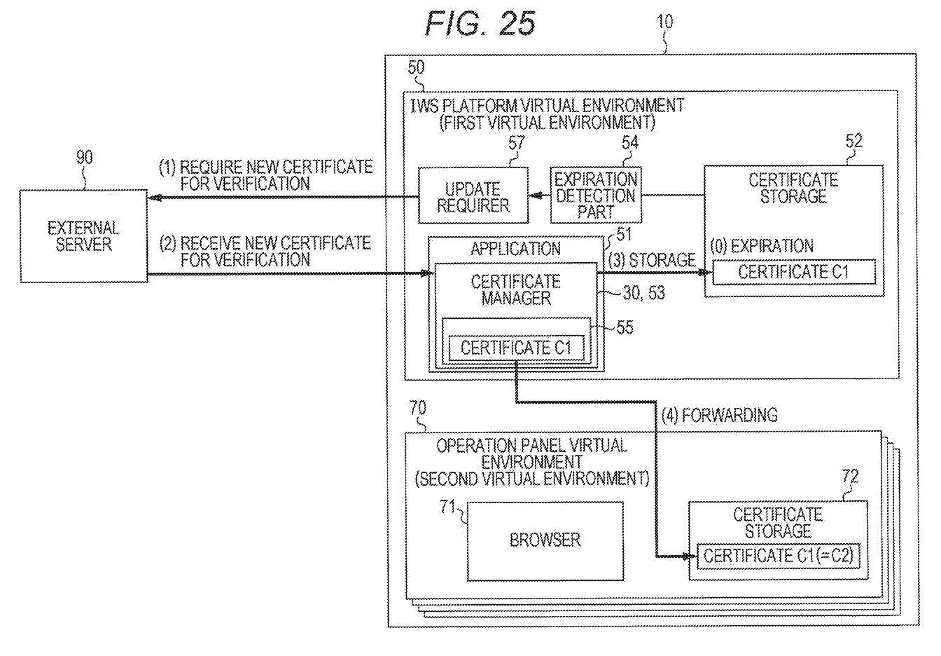

For example, as shown in FIG. 25, the expiration detection part 54 in the first virtual environment 50 may detect the expiration of the first certificate for verification C1, and the update requirer 57 in the first virtual environment 50 may transmit the update requirement of the first certificate for verification C1 to the external server 90. The certificate manager 53 in the first virtual environment 50 may acquire the first certificate for verification C1 after being updated from the external server 90. Thereafter, as shown in FIG. 25, as similar to the first embodiment (see FIG. 6), the certificate manager 53 may transmit the first certificate for verification C1 after being updated to the second virtual environment 70 to store the first certificate for verification C1 after being updated in the certificate storage 72 in the second virtual environment 70. Similarly, the certificate manager 53 may store the first certificate for verification C1 after being updated, also in the certificate storage 52.

### 5. Fifth Embodiment

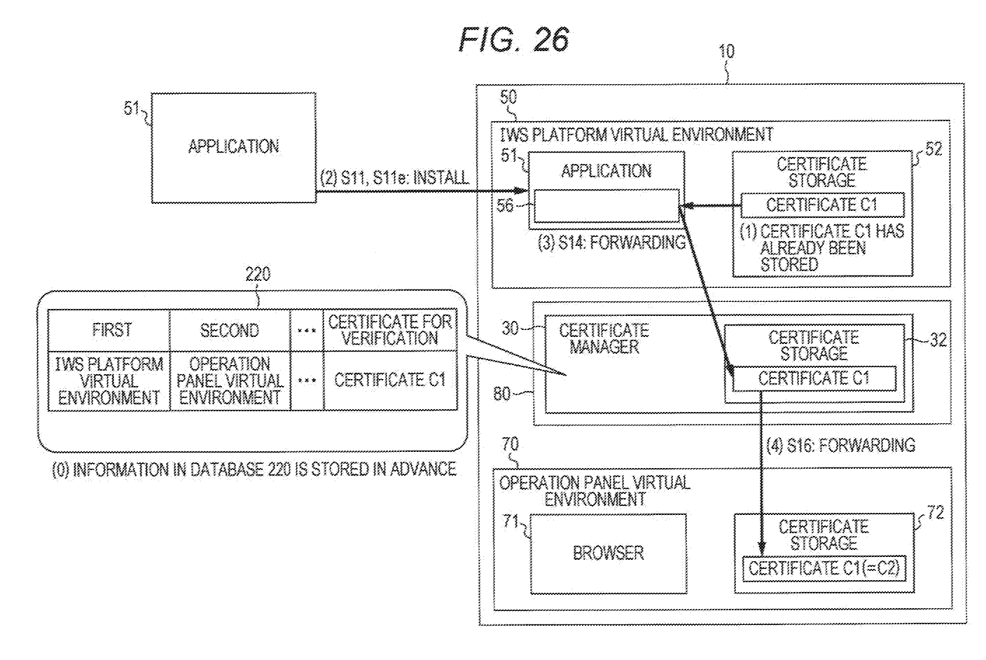

In each of the above embodiments, the first certificate for verification C1 has not yet been stored in the first virtual environment 50 at the time of the construction of the first virtual environment 50 (see FIG. 7 and the like), but the present invention is not limited to this. For example, at the time of the construction of the first virtual environment 50 (for example, at the time of the installation of the guest OS or the like), the first certificate for verification C1 (“certificate for verification by the certificate authority” or “self-signed certificate”) may already have been stored in the first virtual environment 50 (see FIG. 26).

A fifth embodiment is a modification of the second embodiment and the like. Description will be given below mainly for differences from the second embodiment.

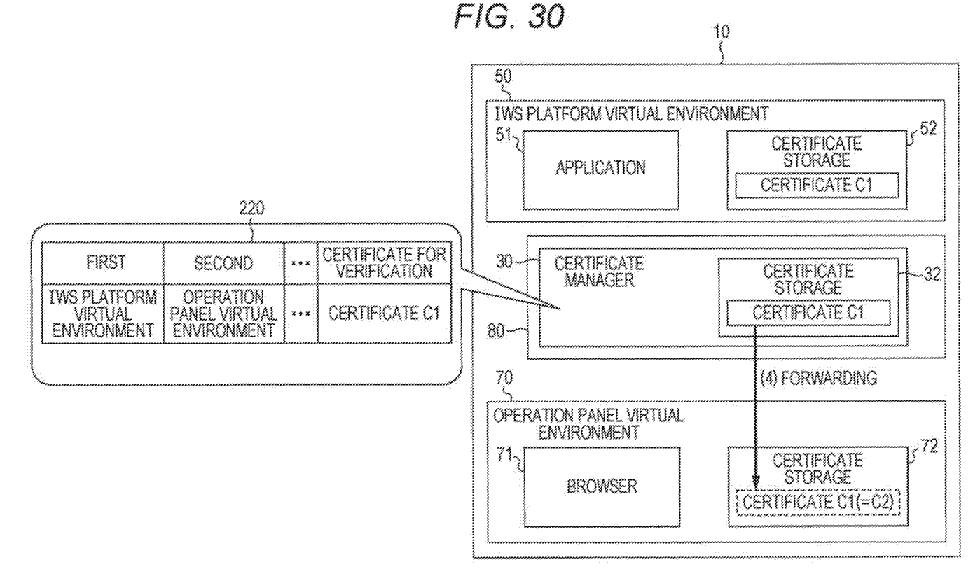

In the fifth embodiment, as shown in FIG. 26, when the first application 51 is installed in the first virtual environment 50 constructed in the MFP 10, the first certificate for verification C1 is extracted and acquired from the certificate storage 52 in the first virtual environment 50. Thereafter, the acquired first certificate for verification C1 is stored in the second virtual environment 70, as the second certificate for verification C2. Such an aspect will be described with reference to FIGS. 26 to 30. FIGS. 27 to 30 are diagrams sequentially showing states at each time point. FIG. 26 is a diagram collectively showing the state transitions of FIGS. 27 to 30.

In the fifth embodiment, as shown in FIG. 27, at the time of the construction of the first virtual environment 50, the first certificate for verification C1 has already been stored in the first virtual environment 50 (unlike the first and second embodiments (see FIG. 7) and the like).

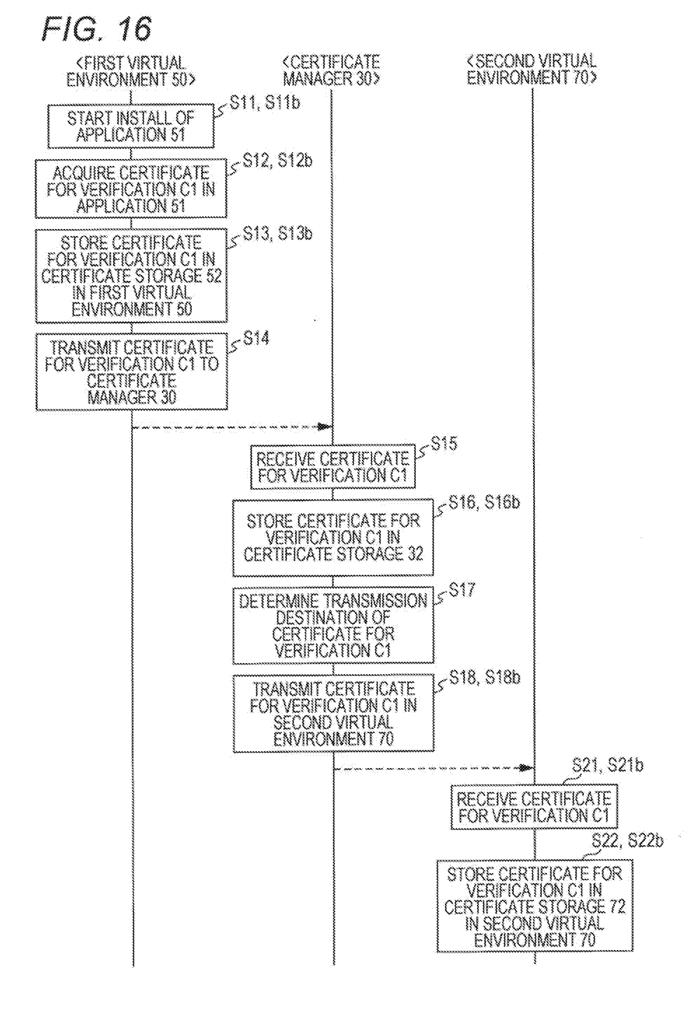

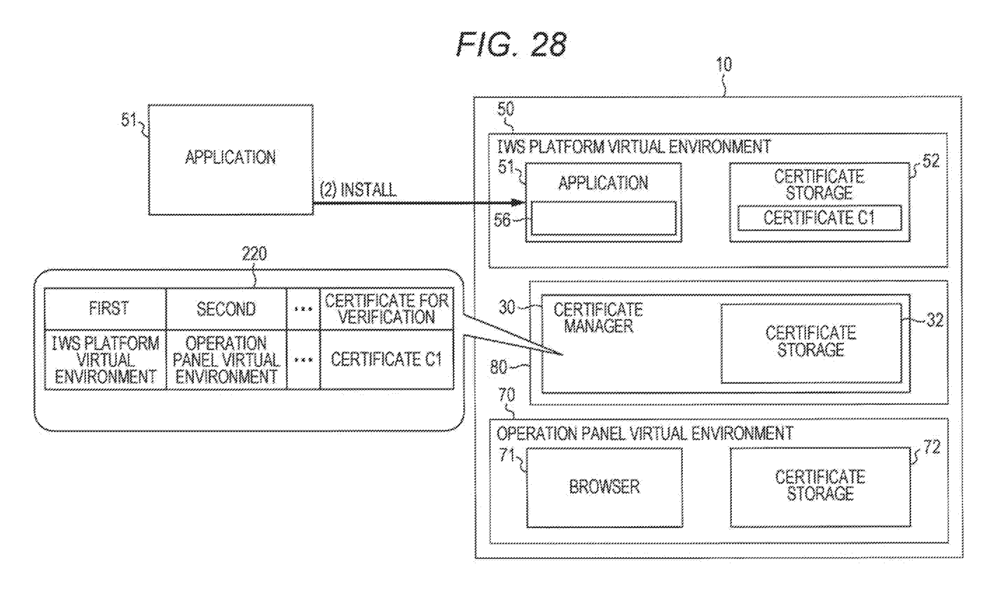

After that, when the installation of the first application 51 is started (see FIG. 28), in step S12 (see also FIG. 16) (S12e), the forwarding processing part 56 in the first virtual environment 50 acquires the certificate for verification C1 that has already been stored in the certificate storage 52 of the first virtual environment 50.

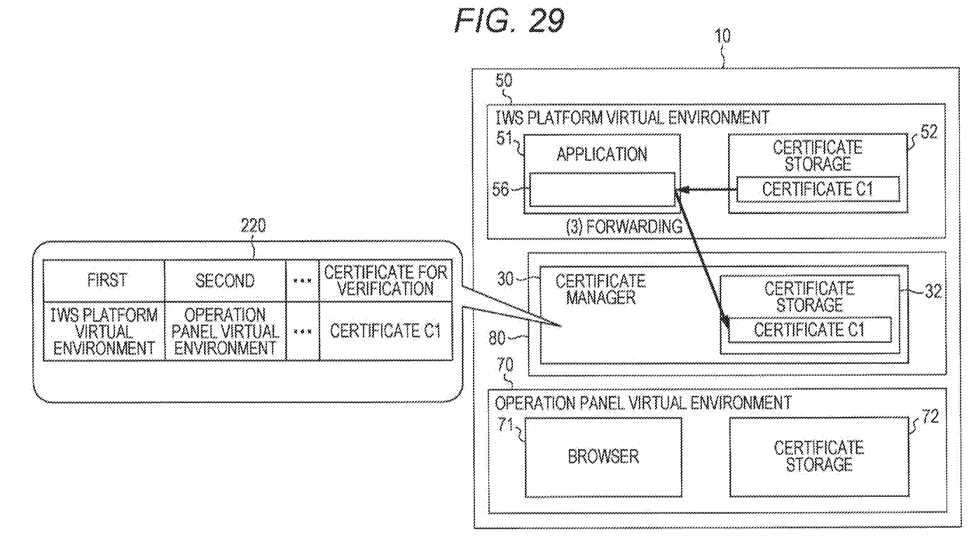

Next, the forwarding processing part 56 transmits the acquired certificate for verification C1 to the certificate manager 30 in the third virtual environment 80, and the certificate manager 30 stores the received first certificate for verification C1 in the certificate storage 32 (see FIG. 29) under the management of the certificate manager 30 (steps S14, S15, S16). As a result, the certificate manager 30 acquires the first certificate for verification C1 stored in advance in the certificate storage 52. In the fifth embodiment, unlike the second embodiment and the like, the processing of step S13 is not performed.

Thereafter, similar operation to that in the second embodiment may be performed.

Here, although the description has mainly been given as a modification of the second embodiment, the present invention is not limited thereto, and modifications similar to those described above may be applied to the first embodiment or the like. In that case, the certificate manager 53 (see FIG. 6) may acquire the first certificate for verification C1 stored in advance in the certificate storage 52 in the first virtual environment 50, and store the acquired first certificate for verification C1 in the certificate storage 72 of the second virtual environment 70, as the second certificate for verification C2.

### 6. Modification Example

Although the embodiments of the present invention have been described above, the present invention is not limited to the above-described contents.

For example, in each of the above embodiments, two virtual environments 50, 70 are constructed in the MFP 10, but the present invention is not limited thereto, and three or more virtual environments may be constructed in the MFP 10. In that case, for example, it is sufficient that the first certificate for verification C1 related to the first virtual environment 50 is automatically stored not only in the certificate storage 72 in the second virtual environment 70 but also in each certificate storage in other virtual environments (third virtual environment, fourth virtual environment, and the like), by the certificate manager 30 or the like.

In the first embodiment and the like, the certificate manager 30(53) operates in accordance with the installation of the first application 51, but the present invention is not limited to this. For example, the certificate manager 30(53) may have already been operated before the installation of the first application 51. Specifically, the certificate manager 53 may be installed separately from the first application 51 at the time of the construction of the first virtual environment 50, immediately after the construction of the first virtual environment 50, or the like and start operating.

Although embodiments of the present invention have been described and illustrated in detail, the disclosed embodiments are made for purposes of illustration and example only and not limitation. The scope of the present invention should be interpreted by terms of the appended claims

What is claimed is:

1. An information processing apparatus that constructs a plurality of virtual environments, the information processing apparatus comprising:
a first storage provided in a first virtual environment of the plurality of virtual environments, the first storage storing a first certificate for verification for verifying a first server certificate transmitted from an external server in execution of a first application in the first virtual environment;
a second storage provided in a second virtual environment of the plurality of virtual environments, the second storage capable of storing a second certificate for verification for verifying a second server certificate transmitted from the external server in execution of a second application in the second virtual environment;
a certificate manager that acquires the first certificate for verification from the first storage or from another part different from the first storage, and automatically stores the first certificate for verification in the second storage, as the second certificate for verification;
a first verification processor that operates in the first virtual environment, and uses the first certificate for verification stored in the first storage to verify the first server certificate; and
a second verification processor that operates in the second virtual environment, and uses the second certificate for verification stored in the second storage to verify the second server certificate.

2. The information processing apparatus according to claim 1, wherein
the certificate manager acquires the first certificate for verification from the outside of the first storage in installation of the first application, and automatically stores the first certificate for verification acquired, in the second storage, as the second certificate for verification.

3. The information processing apparatus according to claim 2, wherein
the certificate manager acquires the first certificate for verification that has been embedded in data for installation of the first application, in installation of the first application, and automatically stores the first certificate for verification that has been acquired, in the second storage, as the second certificate for verification.

4. The information processing apparatus according to claim 2, wherein
the certificate manager stores the first certificate for verification that has been acquired from the outside of the first storage in the first storage, in installation of the first application, and stores the first certificate for verification that has been acquired, in the second storage, as the second certificate for verification.

5. The information processing apparatus according to claim 1, further comprising
a transmission requirer that imparts a transmission requirement of a certificate for verification to be stored in the second virtual environment to the certificate manager, wherein
the certificate manager stores the first certificate for verification that has been stored in the same virtual environment as the virtual environment provided with the certificate manager, in the second storage, as the second certificate for verification, in response to the transmission requirement.

6. The information processing apparatus according to claim 5, wherein
the transmission requirer imparts the transmission requirement after update processing of the second virtual environment is performed.

7. The information processing apparatus according to claim 5, wherein
the transmission requirer imparts the transmission requirement after update processing of the second application is performed.

8. The information processing apparatus according to claim 5, wherein
the transmission requirer imparts the transmission requirement after restoration processing using backup data generated in backup processing of the second virtual environment is performed.

9. The information processing apparatus according to claim 1, further comprising:
a detector that detects expiration of the first certificate for verification; and
an update requirer that transmits an update requirement of the first certificate for verification to the external server when the expiration is detected, wherein
the certificate manager stores the first certificate for verification after being updated that has been sent back in response to the update requirement, in the first storage, and stores the first certificate for verification after being updated also in the second storage.

10. The information processing apparatus according to claim 1, wherein
the certificate manager acquires the first certificate for verification stored in advance in the first storage, and automatically stores the first certificate for verification, in the second storage, as the second certificate for verification.

11. The information processing apparatus according to claim 1, wherein
the certificate manager is provided in the first virtual environment.

12. The information processing apparatus according to claim 1, wherein
the certificate manager is provided in the second virtual environment, or a third virtual environment of the plurality of the virtual environments.

13. The information processing apparatus according to claim 12, wherein
the certificate manager comprises
a third storage capable of storing the first certificate for verification,
the information processing apparatus further comprises
a forwarder that is provided in the first virtual environment and forwards the first certificate for verification to the third storage to store the first certificate for verification in the third storage, and
the certificate manager forwards the first certificate for verification stored in the third storage to the second storage, as the second certificate for verification to store the first certificate for verification in the second storage.

14. The information processing apparatus according to claim 1, wherein
the plurality of virtual environments comprise a plurality of virtual machine environments each operating with a plurality of guest OSs on the same host OS.

15. The information processing apparatus according to claim 1, wherein
the plurality of virtual environments comprise a plurality of virtual container environments each operating with a plurality of containers on the same host OS.

16. The information processing apparatus according to claim 1, wherein
the plurality of virtual environments comprise a plurality of software execution environments each operating with a plurality of pieces of middleware on the same host OS.

17. A control method of an information processing apparatus in which a plurality of virtual environments are constructed, the control method comprising:
a) verifying a first server certificate that is a server certificate transmitted from an external server in execution of a first application in a first virtual environment of the plurality of virtual environments, by utilizing a first certificate for verification stored in a first storage provided in the first virtual environment;
b) acquiring the first certificate for verification from the first storage or another part different from the first storage;
c) verifying a second server certificate that is a server certificate transmitted from the external server in execution of a second application in a second virtual environment of the plurality of virtual environments, by utilizing a second certificate for verification stored in a second storage provided in the second virtual environment; and
d) prior to the c), automatically storing the first certificate for verification that has been acquired in the b) in the second storage provided in the second virtual environment, as the second certificate for verification.

18. The control method according to claim 17, wherein
in the b), the first certificate for verification is acquired from the outside of the first storage in installation of the first application.

19. The control method according to claim 18, wherein
in the b), the first certificate for verification that has been embedded in data for installation of the first application is acquired.

20. The control method according to claim 17, further comprising
e) forwarding the first certificate for verification in the first virtual environment to a third storage provided in a virtual environment other than the first virtual environment to store the first certificate for verification in the third storage, wherein
in the b), the first certificate for verification stored in the third storage is acquired.

21. The control method according to claim 20, wherein
the b) comprises:
b-1) imparting a transmission requirement of a certificate for verification to be stored in the second virtual environment, to a manager that manages a certificate in the third storage; and
b-2) acquiring the first certificate for verification that has been transmitted in response to the transmission requirement.

22. The control method according to claim 17, wherein
the b) comprises:
b-1) imparting a transmission requirement of a certificate for verification to be stored in the second virtual environment, to a manager that manages a certificate in the first storage; and
b-2) acquiring the first certificate for verification that has been transmitted in response to the transmission requirement.

23. The control method according to claim 21, wherein
in the b-1), the transmission requirement is imparted after update processing of the second virtual environment is performed.

24. The control method according to claim 21, wherein
in the b-1), the transmission requirement is imparted after update processing of the second application is performed.

25. The control method according to claim 21, wherein
in the b-1), the transmission requirement is imparted after restoration processing using backup data generated in backup processing of the second virtual environment is performed.

26. The control method according to claim 17, wherein
the b) comprises
b-3) detecting expiration of the first certificate for verification,
b-4) transmitting update requirement of the first certificate for verification to the external server when the expiration is detected, and
b-5) acquiring the first certificate for verification that has been transmitted in response to the update requirement, and
the d) comprises
d-1) storing the first certificate for verification that has been acquired in the b-5), in the first storage, and
d-2) storing the first certificate for verification that has been acquired in the b-5) in the second storage provided in the second virtual environment, as the second certificate for verification.

27. The control method according to claim 17, wherein
in the b), the first certificate for verification that has been stored in advance in the first storage is acquired.

28. A non-transitory recording medium storing a computer readable program causing a computer built in an information processing apparatus to perform:
executing the control method according to claim 17.
